(19) United States
(12) Patent Application Publication
(10) Pub. No.: US 2016/0156570 A1
(43) Pub. Date: Jun. 2, 2016

(54) Method, Storage Medium Storing Management Program, and Storage Medium Storing Terminal Program

(71) Applicant: Brother Kogyo Kabushiki Kaisha, Nagoya-shi (JP)

(72) Inventor: Takafumi Mori, Nagoya-shi (JP)

(21) Appl. No.: 14/955,272

(22) Filed: Dec. 1, 2015

(30) Foreign Application Priority Data
Dec. 1, 2014 (JP) 2014-243019

(51) Int. Cl. H04L 12/911; H04L 12/18; H04L 29/06; G06Q 10/10

(52) U.S. Cl. CPC H04L 47/72; G06Q 10/1095; H04L 12/1818; H04L 65/403

(57) ABSTRACT

A method for a Web conference includes: receiving, through a communication interface, scheduled date and time and reservation conference information; storing, in a storage, conference identification information identifying the Web conference, the scheduled date and time, and the number of license targets in association with one another; counting a total number of the number of license targets of associated Web conferences conducted on the scheduled date and time in a particular period based on the scheduled date and time and the number of license targets; generating reservation status information indicative of a reservation status of the associated Web conferences, based on a number of licenses associated with the requesting user and on the total number of the number of license targets in the particular period; and controlling to display the reservation status information on a display of one of the plurality of terminal apparatuses corresponding to the requesting user.

### CROSS REFERENCE TO RELATED APPLICATIONS

This application claims priority from Japanese Patent Application No. 2014-243019 filed Dec. 1, 2014. The entire content of the priority application is incorporated herein by reference.

### TECHNICAL FIELD

This disclosure relates to a method, a storage medium storing a management program of a management apparatus, a storage medium storing a terminal program of a terminal apparatus that are used in a case where the management apparatus and the terminal apparatus perform communication through a network for conducting an online meeting (e.g., a web conference).

### BACKGROUND

In a known system, each of a plurality of terminal apparatuses performs communication with another terminal apparatus through a management apparatus, in order to conduct a Web conference. There are cases that upper limits are set to the number of participants who participate in Web conferences that are conducted concurrently, the total number of Web conferences that are conducted concurrently, and so on. A system for efficiently reserving, as resources, a meeting room having a video meeting terminal and a multipoint meeting server is disclosed.

### SUMMARY

According to one aspect, this specification discloses a method performed in a communication system configured to conduct a Web conference among a plurality of terminal apparatuses. The method includes: receiving, through a communication interface, scheduled date and time and reservation conference information, the scheduled date and time being date and time on which a Web conference is scheduled to be conducted, and the reservation conference information including a number of license targets; storing, in a storage, conference identification information identifying the Web conference, the scheduled date and time, and the number of license targets in association with one another; counting a total number of the number of license targets of associated Web conferences conducted on the scheduled date and time in a particular period based on the scheduled date and time and the number of license targets stored in the storage, the associated Web conferences being Web conferences associated with a requesting user who requests a reservation status of the Web conferences; generating reservation status information indicative of a reservation status of the associated Web conferences, based on a number of licenses associated with the requesting user and on the total number of the number of license targets in the particular period counted by the counting, the number of licenses defining an upper limit of the number of license targets; and controlling to display the reservation status information on a display of one of the plurality of terminal apparatuses corresponding to the requesting user.

According to another aspect, this specification also discloses a non-transitory computer-readable storage medium storing a program executable on a computer of a management apparatus configured to manage reservation of Web conferences conducted by a plurality of terminal apparatuses. The program causes, when executed, the management apparatus to perform operations comprising: a reservation receiving operation of receiving, through a communication interface of the management apparatus, scheduled date and time and reservation conference information, the scheduled date and time being date and time on which a Web conference is scheduled to be conducted, and the reservation conference information including a number of license targets; a storing controlling operation of storing, in a storage, conference identification information identifying the Web conference, the scheduled date and time, and the number of license targets in association with one another; a first counting operation of counting a total number of the number of license targets of associated Web conferences conducted on the scheduled date and time in a particular period based on the scheduled date and time and the number of license targets stored in the storage, the associated Web conferences being Web conferences associated with a requesting user who requests a reservation status of the Web conferences; a generating operation of generating reservation status information indicative of a reservation status of the associated Web conferences, based on a number of licenses associated with the requesting user and on the total number of the number of license targets in the particular period counted by the first counting operation, the number of licenses defining an upper limit of the number of license targets; and a first transmitting operation of transmitting, through the communication interface, the reservation status information generated by the generating operation to at least one of the plurality of terminal apparatuses.

According to still another aspect, this specification also discloses a non-transitory computer-readable storage medium storing a program executable on a computer of a terminal apparatus configured to make a reservation of a Web conference managed by a management apparatus. The program causes, when executed, the terminal apparatus to perform operations comprising: a first transmitting operation of transmitting, to the management apparatus through a communication interface of the terminal apparatus, user identification information identifying a user, scheduled date and time that is date and time on which a Web conference is scheduled to be conducted, and reservation conference information including a number of license targets; a first counting operation of counting a total number of the number of license targets of associated Web conferences to be conducted on the scheduled date and time in a particular period, the associated Web conferences being associated with the user identification information transmitted by the first transmitting operation; a generating operation of generating reservation status information indicative of a reservation status of the associated Web conferences, based on a number of licenses associated with the user identification information transmitted by the first transmitting operation and on the total number of the number of license targets in the particular period counted by the first counting operation, the number of licenses defining an upper limit of the number of license targets; and a displaying operation of displaying, on a display of the terminal apparatus, the reservation status information generated by the generating operation.

### BRIEF DESCRIPTION OF THE DRAWINGS

Embodiments in accordance with this disclosure will be described in detail with reference to the following figures wherein:

FIG. 1 illustrates the outline of a communication system 1 and the electrical configuration of a management apparatus 11 and terminal apparatuses 12;

FIG. 2 shows tables 114A to 114D;

FIG. 3 shows tables 113A to 113C;

FIG. 4 is a flowchart showing a part of a first main process;

FIG. 5 is a flowchart showing the remaining part of the first main process of FIG. 4;

FIG. 6 shows a reservation screen 2;

FIG. 7 shows a reservation screen 2A;

FIG. 8 shows a daily calendar screen 3;

FIG. 9 shows a weekly calendar screen 4;

FIG. 10 shows a monthly calendar screen 5;

FIG. 11 is a flowchart showing a second main process;

FIG. 12 is a flowchart showing a determining process;

FIG. 13 is a flowchart showing a determining process according to a first modification; and

FIG. 14 is a flowchart showing a determining process according to a second modification.

### DETAILED DESCRIPTION

For example, in some cases, in a Web conference system, an upper limit of the number of participants who participate in a Web conference or the total number of Web conferences is set as the number of licenses. Further, there is a case that usage of a Web conference system is licensed at a rate depending on this number of licenses. If usage exceeds the number of licenses, there is a possibility that a status that is inconvenient to participants of a Web conference occurs, such as that a Web conference cannot be conducted and that an additional charge is imposed.

However, a system for reserving a meeting room and a multipoint meeting server as resources is only disclosed. Hence, even if such technology is applied to a Web conference system, for example, when a user of Web conference makes a reservation to conduct a Web conference, the user is not notified about the number of participants for which reservation has been already received or the total number of Web conferences, relative to the number of participants or the total number of Web conferences that is set as the number of licenses. Accordingly, there is a problem that, when making a reservation to conduct a Web conference, the user cannot grasp whether the number of participants or the total number of Web conferences is less than or equal to the number of licenses.

An example of the objective of an aspect of this disclosure is to provide a management program, a management apparatus, a method, and a terminal program that, when a user makes a reservation to conduct a Web conference, the user can grasp whether the number of participants or the total number of Web conferences is less than or equal to the number of licenses.

<Overview of Communication System 1>

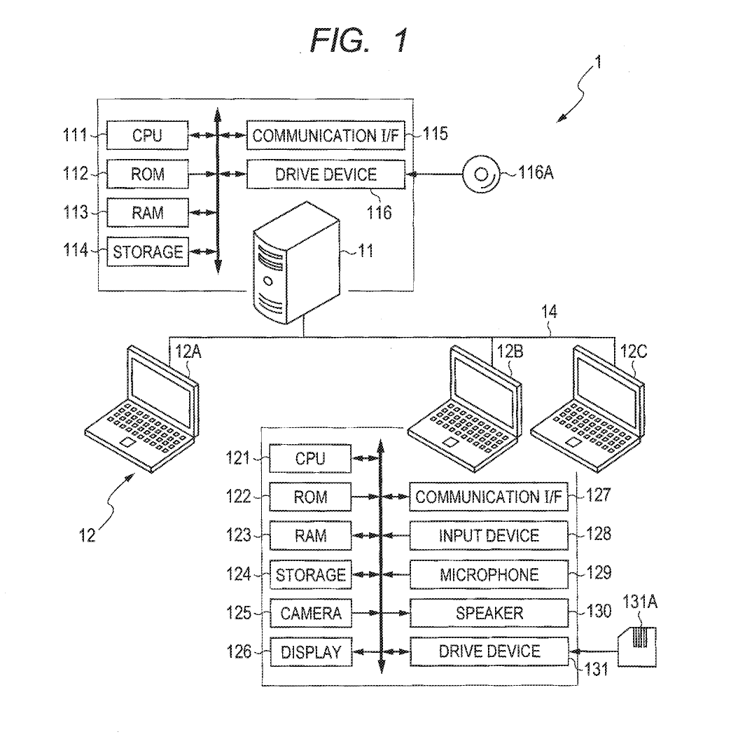

A communication system 1 will be described while referring to FIG. 1. The communication system 1 includes a management apparatus 11 and terminal apparatuses 12A, 12B, 12C. Here, when the terminal apparatuses 12A, 12B, 12C are not differentiated from one another or when the terminal apparatuses 12A, 12B, 12C are referred to collectively, a term “terminal apparatus 12” is used. The management apparatus 11 and the terminal apparatuses 12 are connected with each other through Internet 14 so as to communicate with each other. The communication system 1 is a system for realizing a Web conference among each user of the terminal apparatuses 12.

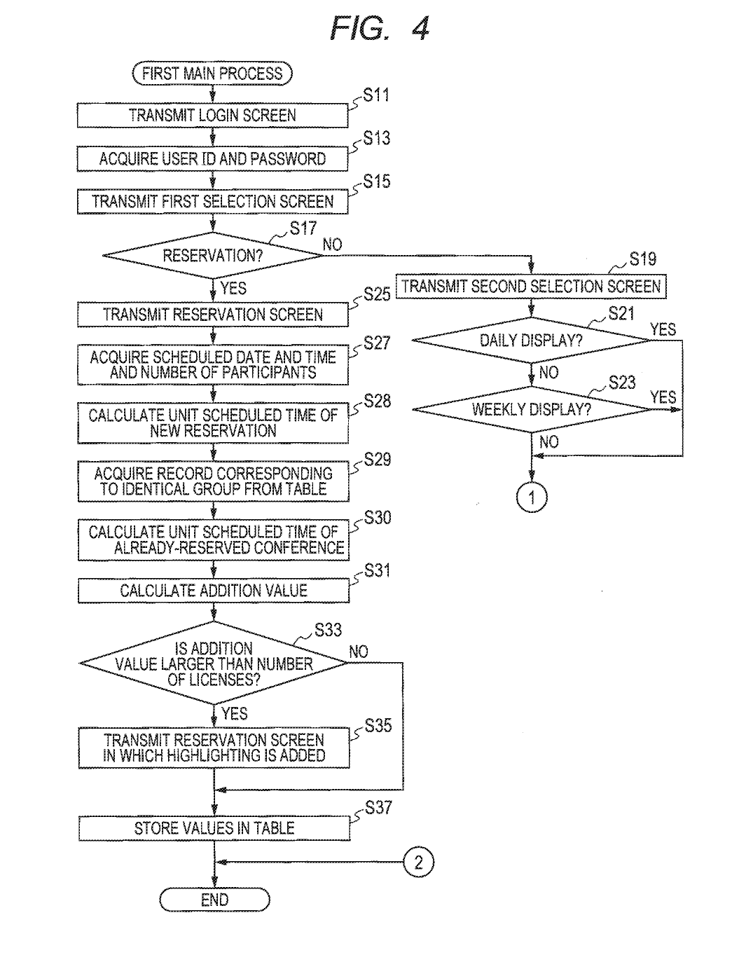

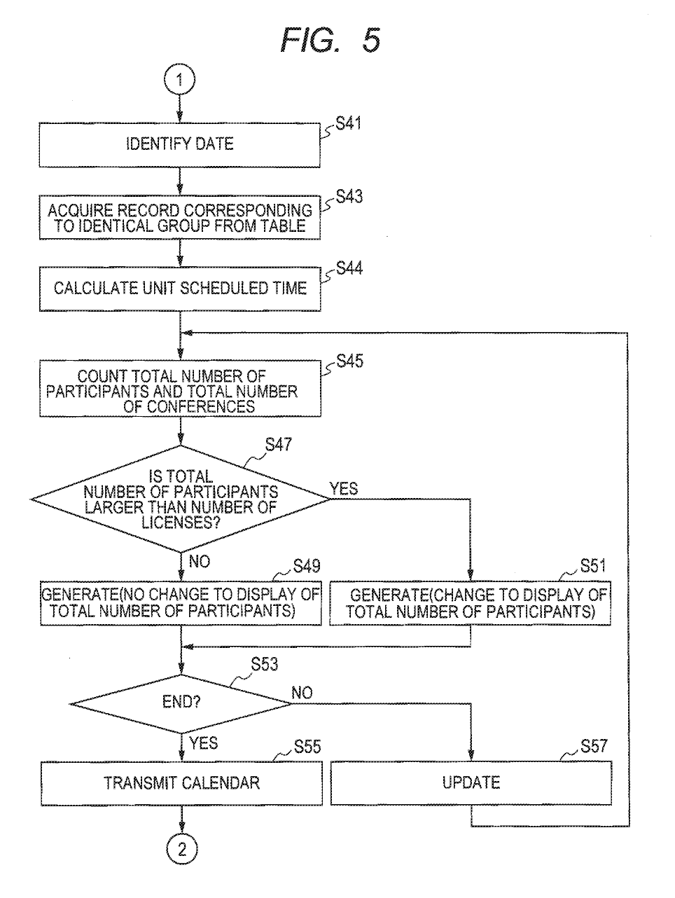

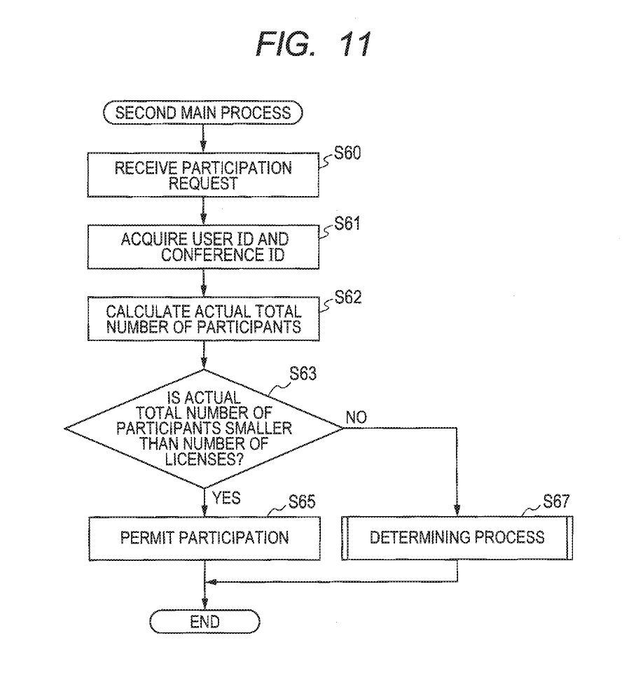

The management apparatus 11 is configured by installing, on a well-known Multi-point Control Unit (MCU), an application for executing a first main process shown in FIGS. 4 and 5 and a second main process shown in FIGS. 11 to 14 described later. The terminal apparatus 12 is configured by a well-known general-purpose Personal Computer (PC). Note that the management apparatus 11 may be configured by installing an application on a general-purpose server. At least one of the terminal apparatuses 12 may be configured by installing an application on a specific terminal dedicated for Web conference.

In the communication system 1, a license for realizing a Web conference among each user is granted for each group. A group in the present embodiment is a department in a company, an organization such as a company, and so on. In the communication system 1, an upper limit of the number of all the participants who can participate in Web conferences that are conducted concurrently is set to the license that is granted to each group. Hereinafter, a set upper limit of the number of participants is referred to as “number of licenses”. The fee in the case of granting license is set depending on the number of licenses. Hence, as the number of licenses is larger, the fee for license may become higher. In the communication system 1, a number of excess licenses may be set for each license. The number of excess licenses identifies an upper limit of the excess number (the number of excess) when the number of all the participants who participate in Web conferences exceeds the number of licenses, so that Web conferences can be conducted even when the number of participants exceeds the number of licenses. That is, for example, if the number of participants exceeds the number of licenses and if the number of excess is less than or equal to the number of excess licenses, a Web conference that is currently conducted may be continued. However, if the number of participants exceeds the number of licenses, an excess fee may be imposed.

<Electrical Configuration of Management Apparatus 11>

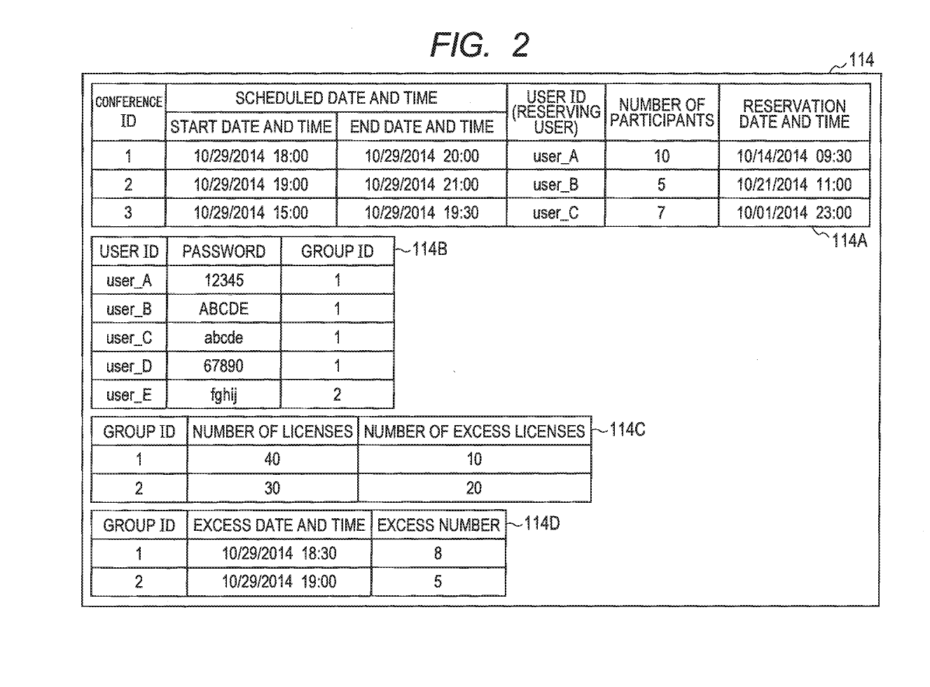

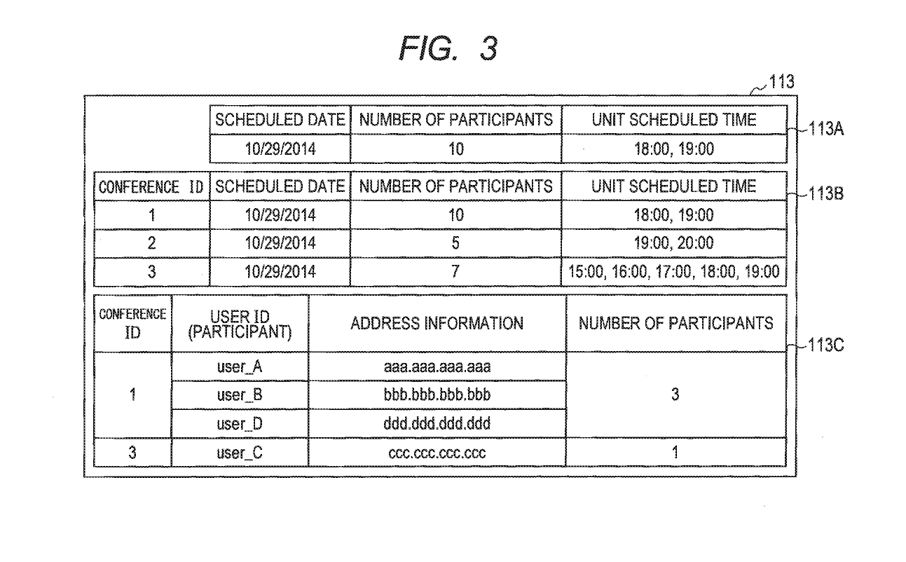

The electrical configuration of the management apparatus 11 will be described while referring to FIG. 1. The management apparatus 11 includes a CPU 111 that controls the management apparatus 11. The CPU 111 is electrically connected to a ROM 112, a RAM 113, a storage 114, a communication interface (I/F) 115, and a drive device 116. The ROM 112 stores a boot program, a Basic Input/Output System (BIOS), and so on. The RAM 113 stores a timer, a counter, and transitory data. The RAM 113 also stores tables 113A to 113C shown in FIG. 3 described later. The timer is updated at a particular cycle (for example, 1 ms) by a timer function provided in an Operating System (OS) described later. The storage 114 includes a non-transitory computer-readable storage medium that is, for example, a hard disk. The storage 114 stores an application program that makes the CPU 111 execute processing (hereinafter simply referred to as “program”) and an operating system (OS). The storage 114 also stores tables 114A to 114D shown in FIG. 2, which are described later. The storage 114 may include, for example, a flash memory and/or a ROM. Any storage medium may be used as the non-transitory storage medium as long as the medium can store information regardless of a time period in which information is stored. The non-transitory storage medium may exclude a transitory storage medium such as transmission signals.

The communication I/F 115 is an interface element (for example, LAN card) through which the management apparatus 11 connects to the Internet 14. The CPU 111 controls the communication I/F 115 to transmit/receive data to/from other devices connected to the Internet 14 (hereinafter, simply referred to as “the CPU 111 transmits/receives data through the communication I/F 115”, for example). The drive device 116 is configured to read out information stored in a storage medium 116A. The CPU 111 controls the drive device 116 to read out the program stored in the storage medium 116A and stores the program in the storage 114.

The tables 114A to 114D stored in the storage 114 will be described while referring to FIG. 2. In the first table 114A, “conference ID”, “scheduled date and time”, “user ID”, “number of participants”, and “reservation date and time” are associated with one another. The “conference ID” is identification information for identifying a reserved Web conference. The “scheduled date and time” includes “start date and time” and “end date and time”. The “start date and time” indicates date and time when a Web conference identified by the corresponding “conference ID” is scheduled to be started. The “end date and time” indicates date and time when the Web conference identified by the corresponding “conference ID” is scheduled to be ended. The “user ID” is identification information for identifying a user who has reserved the Web conference identified by the corresponding “conference ID”. The “number of participants” indicates the number of users who plan to participate in the Web conference identified by the corresponding “conference ID”. The “reservation date and time” indicates date and time when the Web conference identified by corresponding “conference ID” is reserved. Note that “reservation date and time” is information needed in a first modification described later, and is not used in the present embodiment.

In the second table 114B, “user ID”, “password”, and “group ID” are associated with one another. The “password” is a plurality of letters or numbers for authenticating a user identified by the corresponding user ID. The “group ID” as an example of attribute information is identification information for identifying a group to which the user identified by the corresponding user ID belongs. Note that the “password” is not limited to the above-described example. For example, the “password” may be a plurality of letters or numbers that have been converted by hash (one-way function).

In the third table 114C, “group ID”, “number of licenses”, and “number of excess licenses” are stored in association with each other. The “number of licenses” indicates the number of licenses that is granted to a group identified by a corresponding group ID. The “number of excess licenses” indicates the number of excess license that is granted to the group identified by the corresponding group ID. The excess license is license for allowing a Web conference to be conducted continuously even when the number of participants exceeds the number of licenses. The excess license indicates an upper limit of the number of excess relative to the number of licenses. Note that the excess license is granted by paying a particular additional fee in addition to the fee of license. By granting the excess license, when the number of participants exceeds the number of licenses but is within the number of excess licenses, the Web conference is conducted continuously. Note that the “number of excess licenses” is information needed in a second modification described later, and is not used in the present embodiment.

In the fourth table 114D, “group ID”, “excess date and time”, and “excess number” are stored in association with one another. The “excess date and time” indicates date and time when the total number of participants who participate in a Web conferences that are actually conducted exceeds the number of licenses, out of Web conferences reserved by users who belong to the group identified by the corresponding “group ID”. The “excess number” is a value obtained by subtracting the number of licenses from the total number of participants who participate in the Web conferences that are actually conducted, in a case where the total number of participants who participate in the Web conference that is actually conducted exceeds the number of licenses. Note that the fourth table 114D is information needed in the second modification described later, and is not used in the present embodiment.

The seventh table 113C stored in the RAM 113 will be described while referring to FIG. 3. The details of the fifth table 113A and the sixth table 113B will be described later. In the seventh table 113C, “conference ID”, “user ID”, “address information”, and “number of participants” are stored in association with one another. The “conference ID” is identification information for identifying a Web conference that is currently conducted. The “user ID” is identification information for indicating a user who participates in a Web conference identified by the corresponding “conference ID”. The “address information” is address information of the terminal apparatus 12 that is being used by the user identified by the corresponding “user ID”. The “number of participants” is the number of participants who participate in the Web conference identified by the corresponding “conference ID”, and is specifically the total number of the corresponding “user ID”.

Hereinafter, a set of all the information in a correspondence relationship in the tables 114A to 114D and 113C is referred to as “record”. For example, in the first table 114A, the “conference ID”, “scheduled date and time”, “user ID”, “number of participants”, and “reservation date and time” in a correspondence relationship is referred to as a record. In the second table 114B, the “user ID”, “password”, and “group ID” in a correspondence relationship is referred to as a record. In the third table 114C, the “group ID”, “number of licenses”, and “number of excess licenses” in a correspondence relationship is referred to as a record. In the fourth table 114D, the “group ID”, “excess date and time”, and “excess number” in a correspondence relationship is referred to as a record. In the seventh table 113C, the “conference ID”, “user ID”, “address information”, and “number of participants” in a correspondence relationship is referred to as a record. At least one of the tables 114A to 114D and 113C may be stored in a storage of a server apparatus (not shown) connected to the Internet 14, not in the storage 114 of the management apparatus 11. The CPU 111 of the management apparatus 11 may refer to at least one of the tables 114A to 114D and 113C by performing communication with the server.

<Electrical Configuration of Terminal Apparatus 12>

The electrical configuration of the terminal apparatus 12 will be described while referring to FIG. 1. The terminal apparatus 12 includes a CPU 121 that controls the terminal apparatus 12. The CPU 121 is electrically connected to a ROM 122, a RAM 123, a storage 124, a camera 125, a display 126, a communication I/F 127, an input device 128, a microphone 129, a speaker 130, and a drive device 131.

The ROM 122 stores a boot program, a BIOS, and so on. The RAM 123 stores a timer, a counter, flag information, transitory data, and so on. The timer is updated at a particular cycle (for example, 1 ms) by a timer function provided in the OS described later. The storage 124 includes a non-transitory computer-readable storage medium that is, for example, a hard disk. The storage 124 stores the OS and programs for allowing the CPU 121 to execute processing. The storage 124 may include, for example, a flash memory and/or a ROM. Any storage medium may be used as the non-transitory storage medium as long as the medium can store information regardless of a time period in which information is stored. The non-transitory storage medium may exclude a transitory storage medium such as transmission signals.

The display 126 is a Liquid Crystal Display (LCD), for example. The CPU 121 controls the display 126 to display images based on image data (hereinafter, simply referred to as “the CPU 121 displays image on the display 126”, for example). The communication I/F 127 is an interface element (for example, LAN card) through which the terminal apparatus 12 connects to the Internet 14, or another interface element (for example, Wi-Fi communication modem) through which the terminal apparatus 12 connects for wireless communication to an access point (not shown) that is connected to the Internet 14. The CPU 121 controls the communication I/F 127 to transmit/receive data to/from other devices connected to the Internet 14 (hereinafter, simply referred to as “the CPU 121 transmits/receives data through the communication I/F 127”, for example). The input device 128 includes, for example, a button, a keyboard, a mouse, and so on. The drive device 131 is capable of reading out information stored in a computer-readable storage medium 131A, for example, a semiconductor memory. The CPU 121 reads out the program stored in the storage medium 131A by the drive device 131, and stores the read-out program in the storage 124.

The CPU 111 of the management apparatus 11 and the CPU 121 of the terminal apparatus 12 are examples of a hardware processor. The hardware processor may be any processor excluding software. A general-purpose processor may be used as the hardware processor. A part of the process executed by the CPU 111, 121 may be executed by another hardware processor (for example, ASIC). The process executed by the CPU 111, 121 may be distributedly executed by a plurality of electronic devices (that is, a plurality of CPUs). The processes executed by the CPU 111 of the management apparatus 11 may be executed by another server connected to the Internet 14, or may be executed by the CPU 121 of the terminal apparatus 12, for example. The program may be downloaded (that is, being transmitted as transmission signals), for example, from another server connected to the Internet 14, and stored in the storage 114 of the management apparatus 11 or in the storage 124 of the terminal apparatus 12. In this case, the program is stored in a non-transitory storage medium, such as an HDD provided in another server.

<First Main Process>

A first main process executed by the CPU 111 of the management apparatus 11 will be described in detail while referring to the flowcharts in FIGS. 4 and 5. In response to receiving, from the terminal apparatus 12 through the communication I/F 115, a command specifying a path corresponding to a login URL (Uniform Resource Locator), the CPU 111 starts the first main process by executing a program stored in the storage 114. Hereinafter, the command specifying a path corresponding to the login URL is referred to as “first command”.

In response to detecting that an input operation of selecting the login URL displayed on the display 126 has been performed through the input device 128, the CPU 121 of the terminal apparatus 12 transmits a first command to the management apparatus 11 through the communication I/F 127. The management apparatus 11 may preliminarily notify the terminal apparatus 12 about the login URL. The CPU 121 may display the notified login URL on the display 126. The login URL may be inputted directly through the input device 128 by the user of the terminal apparatus 12. The CPU 121 may display the inputted login URL on the display 126.

As shown in FIG. 4, the CPU 111 of the management apparatus 11 transmits login screen data (not shown) to which a user ID and a password can be inputted, to the terminal apparatus 12 having transmitted the first command (S11). The login screen at least includes a text box to which a user ID can be inputted and a text box to which a password can be inputted.

The CPU 121 of the terminal apparatus 12 having transmitted the first command receives login screen data from the management apparatus 11 through the communication I/F 127. The CPU 121 displays a login screen on the display 126 based on the receive data. In response to detecting, through the input device 128, an operation of inputting the user ID and password through the displayed login screen, the CPU 121 identifies the inputted user ID and password. The CPU 121 transmits a command including the identified user ID and password to the management apparatus 11 through the communication I/F 127. Hereinafter, the command including the identified user ID and password is referred to as “second command”.

The CPU 111 of the management apparatus 11 receives the second command from the terminal apparatus 12 through the communication I/F 115. The CPU 111 acquires the user ID and password included in the received second command (S13). The CPU 111 determines whether the password corresponding to the user ID acquired in S13 in the second table 114B shown in FIG. 2 is identical to the password acquired in S13. When it is determined that the passwords are identical, the CPU 111 transmits data of a first selection screen in which “reserve” or “view” can be selected (not shown) to the terminal apparatus 12 having transmitted the second command through the communication I/F 115 (S15). The first selection screen at least includes a check box by which either “reserve” or “view” can be selected. The “reserve” indicates reservation for conducting a Web conference, and the “view” indicates viewing of a reservation status of Web conferences.

The CPU 121 of the terminal apparatus 12 having transmitted the second command receives data of the first selection screen from the management apparatus 11 through the communication I/F 127. The CPU 121 displays the first selection screen on the display 126 based on the received data. In response to detecting that an input operation of selecting one of “reserve” or “view” through the displayed first selection screen has been performed through the input device 128, the CPU 121 transmits, to the management apparatus 11 through the communication I/F 127, a command including information indicative of the selected “reserve” or “view”. Hereinafter, the command including the information indicative of the selected “reserve” or “view” is referred to as “third command”

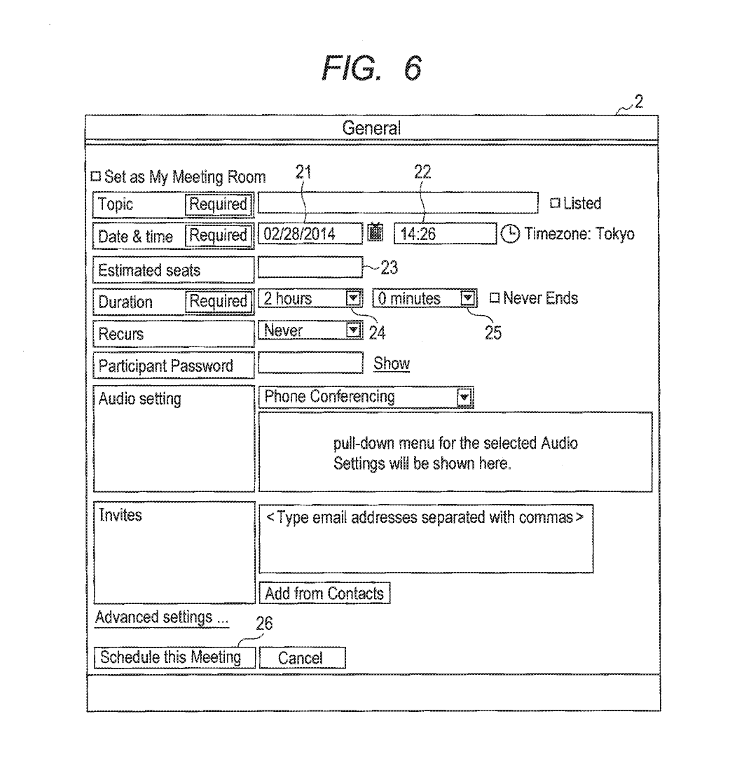

The CPU 111 of the management apparatus 11 receives a third command from the terminal apparatus 12 through the communication I/F 115. The CPU 111 determines whether “reserve” is selected based on the received third command (S17). When it is determined that “reserve” is selected (S17: YES), the CPU 111 transmits data of a reservation screen 2 shown in FIG. 6 to the terminal apparatus 12 having transmitted the third command through the communication I/F 115 (S25).

The CPU 121 of the terminal apparatus 12 having transmitted the third command including information indicative of “reserve” receives the data of the reservation screen 2 shown in FIG. 6 from the management apparatus 11 through the communication I/F 127. The CPU 121 displays the reservation screen 2 on the display 126 based on the receive data.

As shown in FIG. 6, the reservation screen 2 includes a scheduled-date input section 21, a start-time input section 22, a number-of-participant input section 23, duration input sections 24, 25, and a reservation instructing section 26. The scheduled-date input section 21 is a text box for inputting a scheduled date of conducting a reserved Web conference. The start-time input section 22 is a text box for inputting start time of the reserved Web conference. The number-of-participant input section 23 is a text box for inputting the number of participants who plan to participate in the reserved Web conference. The duration input sections 24, 25 are combo boxes for inputting a duration from the start time of the reserved Web conference. The reservation instructing section 26 is a button that is selected at the time of instructing reservation to conduct a Web conference with the particulars inputted in the scheduled-date input section 21, the start-time input section 22, the number-of-participant input section 23, and the duration input sections 24, 25.

In response to detecting an input operation of selecting the reservation instructing section 26 through the reservation screen 2 has been performed through the input device 128, the CPU 121 transmits, to the management apparatus 11 through the communication I/F 127, a command including a scheduled date inputted to the scheduled-date input section 21, start time inputted to the start-time input section 22, end time, and a number of participants inputted to the number-of-participant input section 23. The end time is calculated as time at which the duration inputted to the duration input sections 24, 25 has elapsed from the start time inputted to the start-time input section 22. Here, the CPU 121 may transmit the duration to the management apparatus 11 instead of the end time. In this case, the CPU 111 of the management apparatus calculates the end time based on the start time and the duration. Hereinafter, a command including a scheduled date, start time, end time, and a number of participants is referred to as “fourth command” The scheduled date, the start time, and the end time are collectively referred to as “scheduled date and time”.

As shown in FIG. 4, the CPU 111 of the management apparatus 11 receives a fourth command from the terminal apparatus 12 through the communication I/F 115. The CPU 111 acquires the scheduled date and time and the number of participants included in the received fourth command (S27). The CPU 111 stores the scheduled date of the acquired scheduled date and time and the number of participants in the fifth table 113A of the RAM 113 shown in FIG. 3.

The CPU 111 may identify scheduled time at which a reserved Web conference is scheduled, by the unit of hour, based on the acquired scheduled date and time in S27 (S28). Hereinafter, scheduled time at which a Web conference is scheduled, identified by the unit of hour, is referred to as “unit scheduled time”.

When a period from the start time to “one minute before the end time” is included in any part of one hour of N:00 to N:59 (N is an integer from 0 to 23), out of the scheduled date and time acquired in S27, the CPU 111 identifies N:00 as unit scheduled time of the reserved Web conference. The CPU 111 stores the identified unit scheduled time in the fifth table 113A of the RAM 113 shown in FIG. 3, in association with “scheduled date” and “number of participants”.

An example will be described in which the scheduled date “Oct. 29, 2014” (Oct. 29, 2014), the start time “18:00”, the end time “20:00”, and the number of participants “10” are acquired as the scheduled date and time from the fourth command in S27. In this case, the period from the start time to “one minute before end time” is 18:00 to 19:59. And, 18:00 to 19:59 is included in a period of 18:00 to 18:59 and a period of 19:00 to 19:59. Note that 18:00 to 18:59 corresponds to a case where N is “18”, and 19:00 to 19:59 corresponds to a case where N is “19”. Hence, the CPU 111 identifies “18:00” and “19:00” as the unit scheduled time corresponding to the acquired scheduled date and time. The CPU 111 stores the unit scheduled time “18:00” and “19:00” in the fifth table 113A of the RAM 113 shown in FIG. 3, in association with the scheduled date “Oct. 29, 2014” and the number of participants “10”.

The CPU 111 identifies “group ID” corresponding to the user ID acquired in S13 out of the second table 114B shown in FIG. 2, and further identifies “user ID”s associated with the “group ID” identical to the identified group ID. Hereinafter, in the second table 114B, the “user ID”s associated with the same “group ID” are referred to as “identical group user ID”s. The CPU 111 extracts “user ID” that is the same as the identified identical group user ID in the first table 114A shown in FIG. 2. And, the CPU 111 extracts a record including identical “user ID” (S29). The CPU 111 stores “conference ID” included in the extracted record, “scheduled date” identified from “scheduled date and time”, and “number of participants” in the sixth table 113B of the RAM 113 shown in FIG. 3.

For example, when the user ID acquired in S13 is “user_C”, the CPU111 refers to the second table 114B and identifies the group ID “1” corresponding to the user ID “user_C”, and further identifies “user_A”, “user_B”, “user_C”, and “user_D” associated with the group ID “1” as the identical group user ID. Further, the CPU 111 extracts user IDs “user_A”, “user_B”, and “user_C” identical to the identical group user ID in the first table 114A, and extracts records including those user IDs (the records of the first, second, and third rows in the first table 114A). Then, the CPU 111 stores, in the sixth table 113B, the conference IDs “1”, “2”, “3”, the scheduled dates “October 29”, “October 29”, “October 29”, and the number of participants “10”, “5”, “7”.

The CPU 111 acquires “scheduled date and time” included in the extracted record. The CPU 111 extracts “start time” from “start date and time” of the acquired “scheduled date and time”, and extracts “end time” from “end date and time”. The CPU 111 identifies unit scheduled time for each record, based on the extracted “start time” and “end time” (S30). The CPU 111 stores the identified unit scheduled time in the sixth table 113B of the RAM 113 shown in FIG. 3, in association with “conference ID” included in the corresponding record.

The CPU 111 determines whether “scheduled date” and “unit scheduled time” stored in the fifth table 113A shown in FIG. 3 overlap (that is, at least partially identical to) “scheduled date” and “unit scheduled time” of each record stored in the sixth table 113B shown in FIG. 3. When it is determined that the “scheduled date” and “unit scheduled time” overlap, the CPU 111 extracts and counts (adds) “number of participants” corresponding to the overlapping “scheduled date” and “unit scheduled time” in the sixth table 113B, and calculates a total number of participants. The CPU 111 extracts “number of participants” in the fifth table 113A, and adds the number of participants to the calculated total number of participants, thereby calculating an addition value (S31).

In the example of FIG. 3, the “scheduled date” and “unit scheduled time” of the first, second, and third rows in the sixth table 113B overlap the “scheduled date” and “unit scheduled time” of the fifth table 113A. Thus, the CPU 11 extracts and adds the number of participants “10”, “5”, and “7” of the first, second, and third rows in the sixth table 113B, and calculates the total number of participants “22”. Then, CPU 11 extracts the number of participants “10” of the fifth table 113A, and adds the number of participants “10” to the above-calculated total number of participants “22” to obtain the addition value “32”.

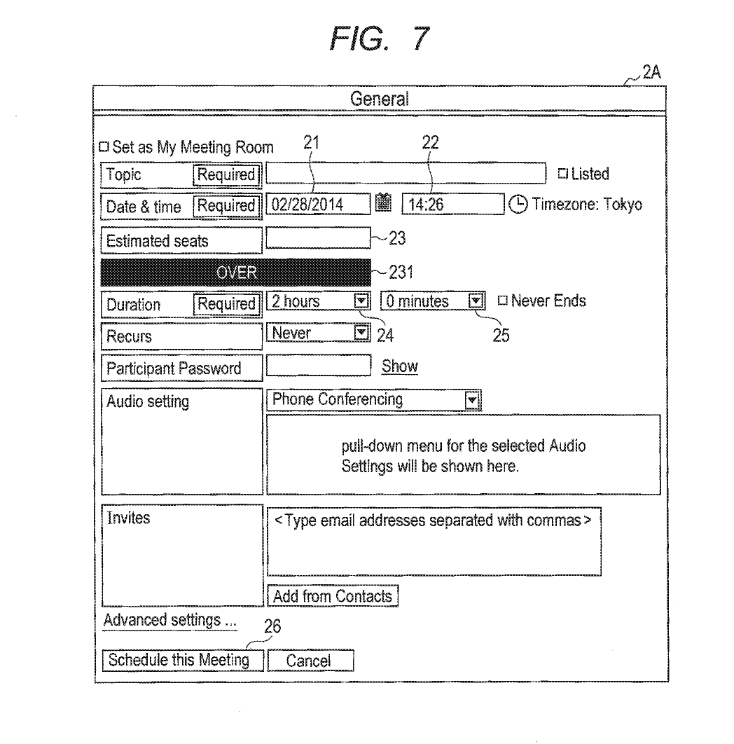

The CPU 111 identifies “group ID” corresponding to the “user ID” acquired in S13 in the second table 114B shown in FIG. 2. The CPU 111 identifies “number of licenses” corresponding to the identified “group ID” in the third table 114C shown in FIG. 2. The CPU 111 determines whether the addition value calculated in S31 is larger than the identified number of licenses (S33). When it is determined that the addition value is not larger than the number of licenses (S33: NO), the CPU 111 advances the process to S37. When it is determined that the addition value is larger than the number of licenses (S33: YES), the CPU 111 transmits data of the reservation screen 2A in which highlighting is added shown in FIG. 7 to the terminal apparatus 12 having transmitted the fourth command through the communication I/F 115 (S35).

In the above-described example, for example, in the process of S33, the CPU 111 may compare the total number of participants with the number of licenses, instead of comparing the addition value with the number of licenses. Alternatively, for example, the CPU 111 may compare the total number of participants with a particular threshold value identified based on the number of licenses.

The CPU 121 of the terminal apparatus 12 having transmitted the fourth command receives data of the reservation screen 2A shown in FIG. 7 from the management apparatus 11 through the communication I/F 127. Based on the received data, the CPU 121 changes the reservation screen 2 shown in FIG. 6 displayed on the display 126 to the reservation screen 2A shown in FIG. 7, and displays the changed reservation screen 2A. In response to detecting that an input operation of selecting the reservation instructing section 26 in the reservation screen 2A has been performed through the input device 128, the CPU 121 transmits, to the management apparatus 11 through the communication I/F 127, a command indicating that the reservation instructing section 26 is selected. In response to receiving, from the terminal apparatus 12, the command indicating that the reservation instructing section 26 is selected, after the process of S35, the CPU 111 of the management apparatus 11 advances the process to S37.

As shown in FIG. 7, the reservation screen 2A is different from the reservation screen 2 shown in FIG. 6, in that highlighting 231 is added to the lower side of the number-of-participant input section 23. The highlighting is attention display for notifying that the addition value is larger than the number of licenses. That is, this attention display indicates that there is a possibility that the Web conference is not conducted. The highlighting is different from display in other parts in color, contrast, pattern, and so on. For example, in the highlighting 231, characters “OVER” in white letters is displayed in a rectangular filled with black. The reservation screen 2A is the same as the reservation screen 2 shown in FIG. 6, except the highlighting 231.

Note that the reservation screen in which highlighting is added is not limited to the reservation screen 2A of FIG. 7, and may be another screen. For example, in the reservation screen 2, bracket lines surrounding the number-of-participant input section 23 may be displayed. Or, for example, in the reservation screen 2, a popup window indicating that the addition value is larger than the number of licenses may be displayed.

As shown in FIG. 4, the CPU 111 identifies the start date and time and the end date and time, based on the scheduled date and time acquired in S27. The CPU 111 stores, in the first table 114A, a value obtained by adding “1” to the largest “conference ID” in the first table 114A shown in FIG. 2, as “conference ID” (S37). The CPU 111 stores the “conference ID” in the first table 114A in association with the identified “start date and time” and “end date and time” (S37). The CPU 111 further stores, in the first table 114A, the “user ID” acquired in S13 and the “number of participants” acquired in S27 in association with the “conference ID” (S37). The CPU 111 acquires current date and time from the OS. The CPU 111 further stores the acquired current date and time as “reservation date and time” in the first table 114A, in association with the “conference ID” (S37). The CPU 111 deletes information stored in the fifth table 113A and the sixth table 113B shown in FIG. 3. The CPU 111 ends the first main process.

On the other hand, when it is determined based on the received third command that “reserve” is not selected (S17: NO), the CPU 111 determines that “view” is selected. The CPU 111 transmits data of a second selection screen (not shown) for selecting one of “daily calendar”, “weekly calendar”, and “monthly calendar” to the terminal apparatus 12 having transmitted the third command through the communication I/F 115 (S19). The second selection screen includes at least a check box for selecting one of “daily calendar”, “weekly calendar”, and “monthly calendar”, and a combo box for specifying “date”.

The CPU 121 of the terminal apparatus 12 having transmitted the third command including information indicative of “view” receives data of the second selection screen from the management apparatus 11 through the communication I/F 127. The CPU 121 displays the second selection screen on the display 126 based on the received data. The CPU 121 selects one of “daily calendar”, “weekly calendar”, and “monthly calendar” through the displayed second selection screen, and detects that an input operation of specifying “date” has been performed through the input device 128. The CPU 121 transmits, to the management apparatus 11 through the communication I/F 127, a command including information identifying the selected one of “daily calendar”, “weekly calendar”, and “monthly calendar” and information indicating the specified “date” Hereinafter, the command including one of “daily calendar”, “weekly calendar”, “monthly calendar” and including “date” is referred to as “fifth command”.

The CPU 111 of the management apparatus 11 receives the fifth command from the terminal apparatus 12 through the communication I/F 115. The CPU 111 determines whether “daily calendar” is selected, based on the received fifth command (S21). When it is determined that “daily calendar” is selected (S21: YES), the CPU 111 advances the process to S41 shown in FIG. 5.

As shown in FIG. 5, the CPU 111 identifies the specified date based on the received fifth command (S41). The CPU 111 identifies the identical group user ID including the user ID acquired in S13, based on the group ID corresponding to the user ID acquired in S13 in the second table 114B shown in FIG. 2. The CPU 111 extracts records including “user ID” identical to the identified identical group user ID in the first table 114A shown in FIG. 2 (S43).

The CPU 111 acquires scheduled date and time included in the extracted record. The CPU 111 extracts start time from the start date and time of the acquired scheduled date and time, and extracts end time from the end date and time. The CPU 111 identifies unit scheduled time for each record, based on the extracted start time and end time (S44). The CPU 111 stores the identified unit scheduled time in the sixth table 113B of the RAM 113 shown in FIG. 3, in association with “conference ID” included in the corresponding record, “scheduled date” identified based on “scheduled date and time”, and “number of participants”.

The CPU 111 selects “0:00” as time. The CPU 111 extracts a record including “scheduled date” identical to the date identified in S41 in the sixth table 113B shown in FIG. 3. The CPU 111 further extracts, from the extracted record, “number of participants” corresponding to “unit scheduled time” identical to the “0:00” selected as time. The CPU 111 counts the extracted number of participants and calculates the number as the total number of participants (S45). The CPU 111 counts the number of “unit scheduled time” identical to “0:00” selected as time, and calculates the number as conference total number (total number of conferences) (S45).

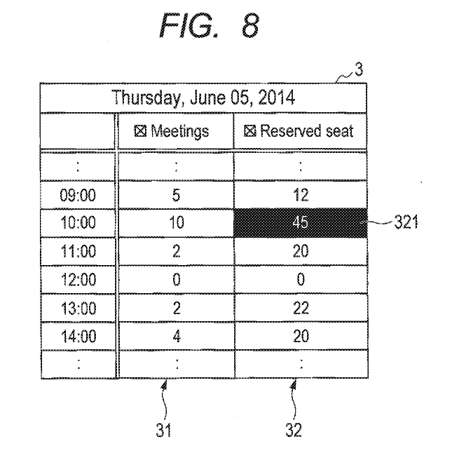

The CPU 111 identifies “group ID” corresponding to the user ID acquired in S13 in the second table 114B shown in FIG. 2. The CPU 111 identifies “number of licenses” corresponding to the identified group ID in the third table 114C shown in FIG. 2. The CPU 111 determines whether the total number of participants calculated in S45 is larger than the identified number of licenses (S47). When it is determined that the total number of participants calculated in S45 is not larger than the number of licenses (S47: NO), the CPU 111 generates a portion corresponding to the selected “0:00” in the daily calendar screen 3 shown in FIG. 8 (S49).

The daily calendar screen 3 transmitted in S55 (described later) will be described while referring to FIG. 8. The daily calendar screen 3 includes a number-of-conference (meeting) display section 31 and a number-of-participant display section 32. The number-of-conference display section 31 and the number-of-participant display section 32 are associated with time from “0:00” to “23:00” by the unit of hour. The number-of-conference display section 31 shows the conference total number of Web conferences that are scheduled to be conducted in a time slot of one hour from the corresponding time. The number-of-participant display section 32 shows the total number of participants of Web conferences that are scheduled to be conducted in a time slot of one hour from the corresponding time. Note that FIG. 8 shows the daily calendar screen 3 after all the times from “0:00” to “23:00” are selected. Hence, at the time when only “0:00” is selected, information is only stored in association with the number-of-conference display section 31 and the number-of-participant display section 32 corresponding to “0:00”.

As shown in FIG. 5, in S49, the CPU 111 inserts the conference total number calculated in S45 to the portion corresponding to the selected “0:00” in the number-of-conference display section 31. The CPU 111 inserts the total number of participants calculated in S45 to the portion corresponding to the selected “0:00” in the number-of-participant display section 32. The CPU 111 advances the process to S53.

The CPU 111 determines whether all and each time of one hour from “0:00” to “23:00” has been selected (S53). When it is determined that not all the time from “0:00” to “23:00” is selected (S53: NO), the CPU 111 updates the selected time by the unit of one hour from “0:00” to obtain “1:00” (S57). The CPU 111 returns the process to S45. The CPU 111 repeats the process based on the updated “1:00”. The CPU 111 repeats the process while changing the selected time, like “2:00”, “3:00”, and so on.

For example, when “10:00” is selected and when it is determined that the total number of participants calculated in S43 is larger than the number of licenses (S47: YES), the CPU 111 generates a portion corresponding to the selected time in the daily calendar screen 3 shown in FIG. 8, as follows (S51). The CPU 111 inserts the conference total number “10” calculated in S45 to the portion corresponding to the selected “10:00” in the number-of-conference display section 31. The CPU 111 inserts the total number of participants “45” calculated in S45 to the portion corresponding to the selected time in the number-of-participant display section 32. Unlike the process in S49, the CPU 111 highlights the total number of participants “45” inserted in the number-of-participant display section 32. The highlighting is display for notifying that the total number of participants is larger than the number of licenses. The highlighting differs from display in other portions in color, contrast, pattern, or the like. For example, as shown in FIG. 8, the CPU 111 fills, in black, a number-of-participant display section 321 in which the total number of participants larger than the number of licenses is inserted. Further, the CPU 111 indicates, in white letters, the total number of participants “45” larger than the number of licenses. As shown in FIG. 5, after the process of S51 ends, the CPU 111 advances the process to S53.

Note that the method of highlighting a particular total number of participants in the daily calendar screen 3 is not limited to the above-described method. For example, in the daily calendar screen 3, a frame border surrounding the number-of-participant display section 32 to be highlighted may be displayed. Alternatively, for example, in the daily calendar screen 3, a pop-up window including the total number of participants and corresponding time to be highlighted may be displayed in an overlapping manner.

The CPU 111 determines whether all the time from “0:00” to “23:00” is selected for each hour (S53). When it is determined that not all the time from “0:00” to “23:00” is selected (S53: NO), the CPU 111 updates time to be selected by the unit of one hour (S57). The CPU 111 returns the process to S45. The CPU 111 repeats the process based on the updated time. When it is determined that all the time from “0:00” to “23:00” is selected (S53: YES), the CPU 111 transmits data indicative of the generated daily calendar screen 3 to the terminal apparatus 12 having transmitted the fifth command including information indicative of “daily calendar” through the communication I/F 115 (S55). The CPU 111 ends the first main process.

The CPU 121 of the terminal apparatus 12 having transmitted the fifth command including the information indicative of “daily calendar” receives data of the daily calendar screen 3 shown in FIG. 8 from the management apparatus 11 through the communication I/F 127. The CPU 121 displays the daily calendar screen 3 on the display 126 based on the received data.

On the other hand, as shown in FIG. 4, when it is determined that the “daily calendar” is not selected based on the received fifth command (S21: NO), the CPU 111 determines whether the “weekly calendar” is selected (S23). When it is determined that the “weekly calendar” is selected (S23: YES), the CPU 111 advances the process to S41 shown in FIG. 5. The process in the case where it is determined that the weekly calendar is selected is substantially the same as the process in the case where it is determined that the daily calendar is selected. Accordingly, processes different from the case where the daily calendar is selected will be mainly described while referring to the same flowchart as the case where the daily calendar is selected, and descriptions of the same processes will be omitted.

In the case of executing the process of S45, the CPU 111 selects the date corresponding to Sunday out of dates in one week including the date identified in S41. The CPU 111 selects “0:00” as time. The CPU 111 extracts a record including “scheduled date” identical to the selected date corresponding to Sunday out of the sixth table 113B shown in FIG. 3. The CPU 111 further extracts, from the extracted record, “number of participants” corresponding to “unit scheduled time” identical to “0:00” selected as time. The CPU 111 counts the extracted number of participants, and calculates the total number of participants (S45). The CPU 111 counts the number of “unit scheduled time” identical to “0:00” selected as time, and calculate the conference total number (S45).

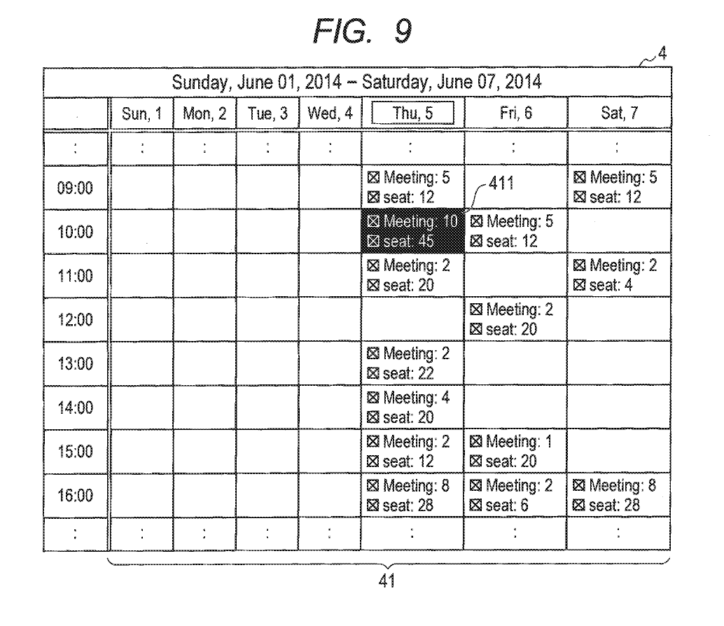

The CPU 111 determines whether the total number of participants calculated in S45 is larger than the number of licenses (S47). When it is determined that the total number of participants calculated in S45 is not larger than the number of licenses (S47: NO), the CPU 111 generates a portion corresponding to the selected Sunday and “0:00” in a weekly calendar screen 4 shown in FIG. 9 (S49).

The weekly calendar screen 4 transmitted in S55 (described later) will be described while referring to FIG. 9. The weekly calendar screen 4 includes a schedule display section 41. The schedule display section 41 is associated with each time from “0:00” to “23:00” by the unit of one hour. Further, the schedule display section 41 is associated with dates and days of week from Sunday to Saturday. In the schedule display section 41, the conference total number of Web conferences scheduled in a one-hour time slot of a corresponding day of week and time is shown at the right side of “Conference”. Also, in the schedule display section 41, the total number of participants of Web conferences scheduled in a one-hour time slot of a corresponding day of week and time is shown at the right side of “seat”. Note that FIG. 9 shows the weekly calendar screen 4 in a state after all the time from “0:00” to “23:00” and all the dates of one week from Sunday to Saturday are selected. Hence, at the time point when only “0:00” and the date corresponding to Sunday are selected, information is associated only with the schedule display section 41 corresponding to “0:00” and “Sun”.

As shown in FIG. 5, in the process of S49, the CPU 111 inserts the conference total number and the total number of participants calculated in S45 to the portion corresponding to the selected Sunday and “0:00” in the schedule display section 41. The CPU 111 advances the process to S53.

The CPU 111 determines whether all and each time of one hour from “0:00” to “23:00” has been selected (S53). When it is determined that not all the time of one hour from “0:00” to “23:00” is selected (S53: NO), the CPU 111 updates time to be selected by the unit of one hour from “0:00” to obtain “1:00” (S57). The CPU 111 returns the process to S45. The CPU 111 repeats the process based on the updated time “1:00”. The CPU 111 repeats the process while changing the time to be selected, like “2:00”, “3:00”, and so on. When it is determined that all the time of one hour from “0:00” to “23:00” is selected, the CPU 111 determines whether all dates of one week have been selected (S53). When it is determined that not all dates of one week are selected (S53: NO), the CPU 111 updates the day of week to be selected from Sunday to Monday, and updates the corresponding date by one day (S57). The CPU 111 returns the process to S45. The CPU 111 repeats the process while sequentially selecting time from “0:00” to “23:00” for the updated Monday and changing the day of week like Tuesday, Wednesday, and so on.

For example, when Thursday (Thu) and “10:00” is selected and it is determined that the total number of participants calculated in S45 is larger than the number of licenses (S47: YES), the CPU 111 generates a portion corresponding to the selected date and time in the weekly calendar screen 4 shown in FIG. 9, as follows (S51). The CPU 111 inserts the conference total number “10” and the total number of participants “45” calculated in S45 to the portion corresponding to date “5th” corresponding to the selected Thursday and “10:00” in the schedule display section 41. Unlike the process of S49, the CPU 111 highlights the conference total number “10” and the total number of participants “45” inserted in the schedule display section 41. Specifically, as shown in FIG. 9, the CPU 111 fills, in black the schedule display section 411 in which the total number of participants and the conference total number larger than the license are inserted. Further, the CPU 111 indicates, in white letters, the total number of participants “45” larger than the number of licenses and the conference total number “10”. As shown in FIG. 5, after finishing the process of S51, the CPU 111 advances the process to S53.

Note that the method of highlighting a particular total number of participants in the weekly calendar screen 4 is not limited to the above-described method. For example, in the weekly calendar screen 4, a frame border surrounding the schedule display section 411 to be highlighted may be displayed. Or, for example, in the weekly calendar screen 4, a popup window including the total number of participants and corresponding date to be highlighted may be displayed in an overlapping manner.

The CPU 111 determines whether all and each time from “0:00” to “23:00” of one hour has been selected (S53). When it is determined that not all the time from “0:00” to “23:00” is selected (S53: NO), the CPU 111 updates the time to be selected by the unit of one hour (S57). The CPU 111 returns the process to S45. Further, when it is determined that all the times from “0:00” to “23:00” are selected, the CPU 111 determines whether all the dates of one week have been selected (S53). When it is determined that not all the dates of one week are selected (S53: NO), the CPU 111 updates the day of week to be selected and updates the corresponding date by one day (S57). The CPU 111 returns the process to S45. On the other hand, when it is determined that all the times from “0:00” to “23:00” have been selected and that all the dates of one week have been selected (S53: YES), the CPU 111 transmits data indicative of the generated weekly calendar screen 4 to the terminal apparatus 12 having transmitted the fifth command including information indicative of “weekly calendar” (S55). The CPU 111 ends the first main process.

The CPU 121 of the terminal apparatus 12 having transmitted the fifth command including information indicative of “weekly calendar” receives data of the weekly calendar screen 4 shown in FIG. 9 from the management apparatus 11 through the communication I/F 127. The CPU 121 displays the weekly calendar screen 4 on the display 126 based on the received data.

On the other hand, as shown in FIG. 4, when it is determined that “weekly calendar” is not selected based on the received fifth command (S23: NO), the CPU 111 determines that “monthly calendar” is selected and advances the process to S41 shown in FIG. 5. The processes in the case where it is determined that the monthly calendar is selected are substantially the same as the processes in the case where it is determined that the daily calendar or the weekly calendar is selected. Accordingly, the processes different from the case where the daily calendar or the weekly calendar is selected will be mainly described while referring to the same flowchart as the case where the daily calendar is selected, and description of identical processes will be omitted or simplified.

In executing the process of S45, the CPU 111 selects the first date of dates of one month including the date identified in S41. The CPU 111 sequentially selects each time from “0:00” to “23:00” of one hour. The CPU 111 extracts records including “scheduled date” identical to the first date in the sixth table 113B shown in FIG. 3. The CPU 111 further extracts “number of participants” corresponding to the identical “unit scheduled time”, for each of “0:00” to “23:00” selected sequentially as the time. The CPU 111 counts the extracted number of participants, and calculates the total number of participants corresponding to “unit scheduled time” of each of “0:00” to “23:00” (S45). The CPU 111 counts the number of the identical unit scheduled times for each of “0:00” to “23:00” selected sequentially as the time, and calculates the conference total number corresponding to each of “0:00” to “23:00” (S45).

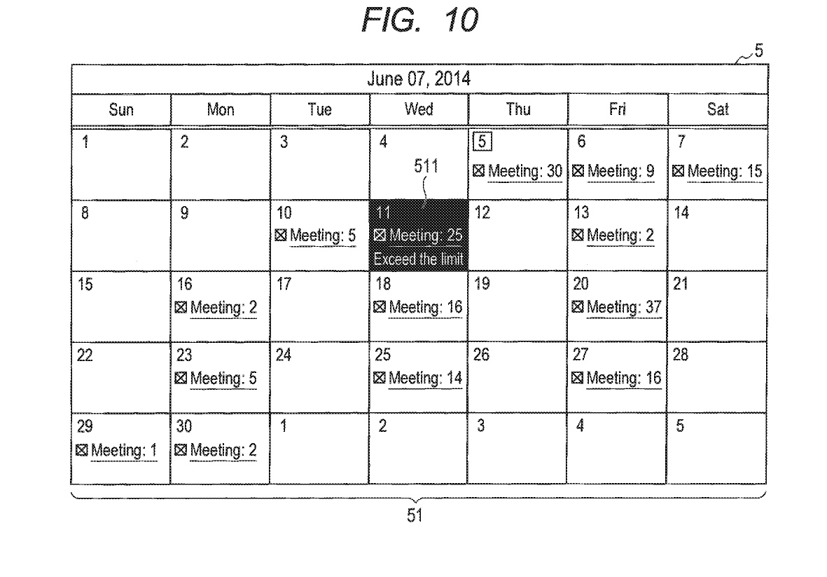

The CPU 111 determines whether any one of the total number of participants calculated for each time in S45 is larger than the number of licenses (S47). When it is determined that none of the total number of participants calculated for each time in S45 is larger than the number of licenses (S47: NO), the CPU 111 generates a portion corresponding to the first date in the monthly calendar screen 5 shown in FIG. 10 (S49).

The monthly calendar screen 5 transmitted in S55 (described later) will be described while referring to FIG. 10. The monthly calendar screen 5 includes a schedule display section 51. The schedule display section 51 is associated with each date of one month. In the schedule display section 51, the total number of all the Web conferences scheduled to be conducted on a corresponding date is shown at the right side of “Conference”. Note that FIG. 10 shows the monthly calendar screen 5 in a state after all the dates of one month are selected. Hence, at the time when only the first date is selected, information is only stored in association with the portion of the schedule display section 51 corresponding to the first date.

As shown in FIG. 5, in S49, the CPU 111 inserts the conference total number calculated in S45 to the portion corresponding to the first date in the schedule display section 51. The CPU 111 advances the process to S53.

The CPU 111 determines whether all the dates of one month have been selected (S53). When it is determined that not all the dates of one month are selected (S53: NO), the CPU 111 updates the date to be selected by one day and obtains the second day (S57). The CPU 111 returns the process to S45. The CPU 111 repeats the process while updating the date, like the second day, the third day, and so on.

For example, when the 11th day is selected and when it is determined that any one of the total number of participants calculated for each time in S45 is larger than the number of licenses (S47: YES), the CPU 111 generates a portion corresponding to the selected date in the monthly calendar screen 5 shown in FIG. 10, as follows (S51). The CPU 111 inserts the conference total number “25” calculated in S45 to the portion corresponding to the selected 11th day in the schedule display section 51. Unlike the process of S49, the CPU 111 highlights the conference total number “25” inserted in the schedule display section 51. Specifically, as shown in FIG. 10, the CPU 111 fills, in black, the schedule display section 511 corresponding to the selected 11th day, and indicates the conference total number “25” in white letters. Further, the CPU 111 inserts white letters indicating “Exceed the limit” in the schedule display section 511. As shown in FIG. 5, after S51, the CPU 111 advances the process to S53.

Note that the method of highlighting a particular date in the monthly calendar screen 5 is not limited to the above-described method. For example, a frame border surrounding the schedule display section 511 to be highlighted may be displayed in the monthly calendar screen 5. Alternatively, for example, in the monthly calendar screen 5, a pop-up window including the date to be highlighted may be displayed in an overlapping manner.

The CPU 111 determines whether all the dates of one month have been selected (S53). When it is determined that not all the dates of one month are selected (S53: NO), the CPU 111 updates the date to be selected by one day (S57). The CPU 111 returns the process to S45. Further, when it is determined that all the dates of one month are selected (S53: YES), the CPU 111 transmits data indicative of the generated monthly calendar screen 5 to the terminal apparatus 12 having transmitted the fifth command including information indicative of “monthly calendar” through the communication I/F 115 (S55). The CPU 111 ends the first main process.

The CPU 121 of the terminal apparatus 12 having transmitted the fifth command including information indicative of “monthly calendar” receives data of the monthly calendar screen 5 shown in FIG. 10 from the management apparatus 11 through the communication I/F 127. The CPU 121 displays the monthly calendar screen 5 on the display 126 based on the received data.

<Second Main Process>

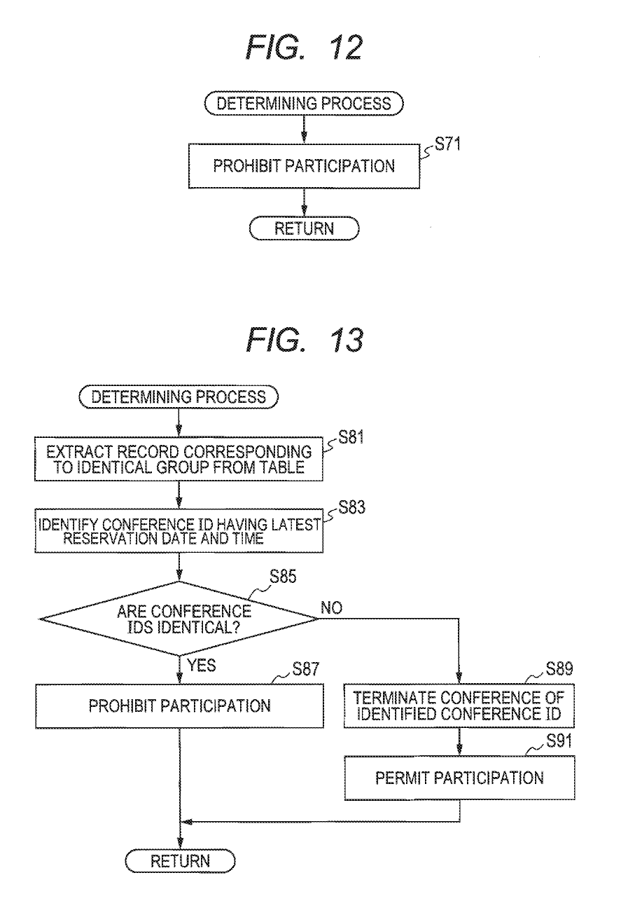

A second main process executed by the CPU 111 of the management apparatus 11 will be described in detail while referring to the flowcharts of FIGS. 11 and 12. In response to receiving, from the terminal apparatus 12, a command specifying a path corresponding to a URL for participating in a Web conference, the CPU 111 starts the second main process by executing the program stored in the storage 114. Hereinafter, the command specifying a path corresponding to a URL for participating in a Web conference will be referred to as “sixth command” The path specified by the sixth command includes a conference ID for identifying a Web conference for which participation is requested, and a user ID of a user who has reserved the Web conference identified by the conference ID.

Although details are omitted, electronic mail attached with a participation URL including the conference ID and the user ID is preliminarily sent to the terminal apparatus 12. The electronic mail may be transmitted by the management apparatus 11, or may be prepared by a user who has reserved the Web conference and transmitted to the terminal apparatus 12. The CPU 121 of the terminal apparatus 12 displays, on the display 126, the participation URL notified by the electronic mail. In response to detecting that an input operation of selecting the participation URL has been performed through the input device 128, the CPU 121 transmits the sixth command to the management apparatus 11.

The CPU 111 of the management apparatus 11 receives a request for participating in a Web conference by receiving the sixth command through the communication I/F 115 (S60). The CPU 111 acquires the user ID and the conference ID included in the received sixth command (S61). The CPU 111 identifies, based on the sixth command, address information of the terminal apparatus 12. The address information is needed for performing communication with the terminal apparatus 12 having transmitted the sixth command. The address information is the IP address of the terminal apparatus 12, for example.

The CPU 111 identifies “user ID” corresponding to the conference ID acquired in S61 in the first table 114A shown in FIG. 2. The CPU 111 identifies, in the second table 114B shown in FIG. 2, identical group user ID including the user ID identified based on “group ID” corresponding to the identified user ID. The CPU 111 extracts the “user ID” identical to the identified identical group user ID out of the first table 114A shown in FIG. 2. And, the CPU 111 extracts a record including this identical “user ID”. The CPU 111 identifies “conference ID” included in the extracted record. The CPU 111 extracts a record including the identified “conference ID” out of the seventh table 113C shown in FIG. 3. The CPU 111 counts the number of participants included in the extracted record, and calculates the actual total number of participants (S62). The CPU 111 identifies the “number of licenses” corresponding to “group ID” identical to the identified identical group user ID in the third table 114C shown in FIG. 2.

For example, when the conference ID acquired in S61 is “2”, the CPU 111 identifies the user ID “user_B” corresponding to the conference ID “2” in the first table 114A. Based on the group ID “1” corresponding to the identified “user_B”, the CPU 111 identifies the identical group user IDs (user_A, user_B, user_C, user_D) in the second table 114B. The CPU 111 extracts the user IDs identical to the identical group user IDs in the first table 114A (user_A, user_B, user_C), and extracts records (the first, second, and third rows) including the extracted user IDs. Then, the CPU 111 identifies the conference IDs “1”, “2”, and “3” included in the extracted records, and extracts records including the identified conference ID in the seventh table 113C (the first and second rows). The CPU 111 counts (adds) the number of participants “3” and “1” included in the extracted records and obtains the actual total number of participants “4” (S62).

The CPU 111 determines whether the actual total number of participants calculated in S62 is smaller than the identified number of licenses (S63). When it is determined that the actual total number of participants is smaller than the number of licenses (S63: YES), the CPU 111 permits participation in the Web conference identified by the conference ID acquired in S61 (S65).

Specifically, the CPU 111 performs communication with the terminal apparatus 12 through the communication I/F 115 based on address information of the terminal apparatus 12 having transmitted the sixth command, and executes a conference connection process. The CPU 111 establishes, with the terminal apparatus 12, a session of the Web conference indicated by the conference ID by the conference connection process.

The CPU 111 stores the conference ID and the user ID acquired in S61 in the seventh table 113C shown in FIG. 3. The CPU 111 further stores address information of the terminal apparatus 12 having transmitted the sixth command in the seventh table 113C, in association with the stored “user ID”. When a conference ID identical to the conference ID acquired in S61 is already stored in the seventh table 113C, the CPU 111 stores the user ID and the address information acquired in S61 in the seventh table 113C, in association with the identical “conference ID” that is already stored. The CPU 111 calculates the total number of “user ID” corresponding to the stored “conference ID” in the seventh table 113C, and stores the total number in the seventh table 113C as the “number of participants”. The CPU 111 ends the second main process.

On the other hand, when it is determined that the actual total number of participants is not smaller than the number of licenses (S63: NO), the CPU 111 executes a determining process shown in FIG. 12 (S67). As shown in FIG. 12, the CPU 111 prohibits participation in the Web conference identified by the conference ID acquired in S61 shown in FIG. 11 (S71). Specifically, the CPU 111 does not execute the conference connection process for connection with the terminal apparatus 12 having transmitted the sixth command, and does not establish a session of the Web conference indicated by the conference ID with the terminal apparatus 12. The CPU 111 returns processing to the second main process shown in FIG. 11. As shown in FIG. 11, after the determining process (S67), the CPU 111 ends the second main process.

### Main Effects of the Present Embodiment

As described above, the CPU 111 of the management apparatus 11 receives the fourth command from the terminal apparatus 12, and acquires the scheduled date and time and the number of participants of the Web conference to be reserved (S27). The CPU 111 stores, in the first table 114A, the “user ID” of a user (reserving user) who has logged in by using the terminal apparatus 12 having transmitted “conference ID”, “scheduled date and time”, “number of participants”, and the fourth command (S37). When the third command is received from the terminal apparatus 12 and it is determined that “view” is selected (S17: NO), the CPU 111 generates a screen indicative of a calendar based on information stored in the tables 114A to 114C, 113C (S49, SM). Specifically, the CPU 111 calculates unit scheduled time for each scheduled date, for each of all the Web conferences that have been reserved by all users (reserving users) belonging to the same group as the requester who is the user who has logged in by using the terminal apparatus 12 having transmitted the third command (S44). The CPU 111 counts the number of participants for each of the calculated unit scheduled times, and calculates the total number of participants (S45). The CPU 111 generates one of the “daily calendar screen 3”, the “weekly calendar screen 4”, and the “monthly calendar screen 5”, based on the number of licenses set for the group to which the requester belongs and on the calculated total number of participants (S49, S51). The CPU 111 transmits data of the generated screen to the terminal apparatus 12 having transmitted the third command (S55).

The terminal apparatus 12 having received data transmitted from the management apparatus 11 displays one of the “daily calendar screen 3”, the “weekly calendar screen 4”, and the “monthly calendar screen 5” on the display 126, based on the received data. In this case, the requester can grasp a relationship between the total number of participants and the number of licenses. Accordingly, for example, at the time of specifying the number of participants and making a reservation for conducting a Web conference, the requester can preliminarily grasp whether the total number of participants is less than or equal to the number of licenses. Further, for example, the requester can adjust the number of participants such that the total number of participants is less than or equal to the number of licenses, and reserve a Web conference.

When the total number of participants is larger than the number of licenses (S47: YES), the CPU 111 generates the “daily calendar screen 3”, the “weekly calendar screen 4”, and the “monthly calendar screen 5” in which a portion to insert the total number of participants is highlighted (S51). Specifically, in the “daily calendar screen 3” or the “weekly calendar screen 4”, scheduled date and time in which the total number of participants larger than the number of licenses is inserted is filled in black, and the total number of participants is shown in white letters (the number-of-participant display section 321, the schedule display section 411). Further, in the “monthly calendar screen 5”, the scheduled date and time to insert the total number of participants larger than the number of licenses is filled in black (the schedule display section 511). With this process, the requester can specifically grasp the relationship between the total number of participants and the number of licenses, in association with calendar. Further, the requester can grasp the relationship between the total number of participants and the number of licenses, for each scheduled date and time. Further, in the “daily calendar screen 3” or the “weekly calendar screen 4”, the total number of participants corresponding to all the scheduled date and time is shown for each scheduled date and time. Thus, the requester can also recognize the total number of participants for scheduled date and time that is not highlighted. Accordingly, the requester can grasp the relationship between the total number of participants and the number of licenses in the entire calendar.

The CPU 111 identifies unit scheduled time for each scheduled date, for each of all the Web conferences that have been reserved by all the reserving users belonging to the same group as the requester. That is, the CPU 111 notifies the requester about the relationship between the total number of participants and the number of licenses in the Web conference relating to the requester, as a reservation status. Hence, the requester can appropriately grasp the relationship between the total number of participants and the number of licenses in the case of reserving a Web conference while specifying the number of participants.

In response to acquiring the scheduled date and time and the number of participants of a Web conference to be reserved (S27), the CPU 111 calculates an addition value by adding the acquired number of participants to the total number of participants calculated based on the Web conferences that are already reserved (S31). Note that all of the reserved Web conferences are not always conducted actually. Also, all of the scheduled participants do not always participate in a Web conference. Accordingly, regardless of whether the addition value is larger than the number of licenses (S33: YES) or smaller than the number of licenses (S33: NO), the CPU 111 stores the “conference ID”, the “scheduled date and time”, the “number of participants”, and the “user ID” in the first table 114A, in order to make reservation for conducting a Web conference (S37). This process suppresses a situation that, when a reserved Web conference is not conducted or when all scheduled participants do not participate in a Web conference, the total number of participants is small relative to the number of licenses and the number of licenses is not used efficiently.

When the calculated addition value is larger than the number of licenses (S33: YES), the CPU 111 transmits, to the terminal apparatus 12, data of the reservation screen 2A to which highlighting is added (S35). For example, when the terminal apparatus 12 has displayed the reservation screen 2A on the display 126, the reserving user can easily grasp that the total number of participants to be updated by reserving the Web conference becomes larger than the number of licenses.

The CPU 111 receives a request for participating in a Web conference by receiving the sixth command from the terminal apparatus 12 (S60). The CPU 111 acquires the user ID and the conference ID included in the sixth command (S61). The CPU 111 calculates the actual total number of participants corresponding to Web conferences that are actually conducted, out of all the Web conferences reserved by all the reserving users belonging to the same group as the user identified by the acquired user ID, and compares the actual total number of participants with the number of licenses (S63). When the actual total number of participants is smaller than the number of licenses (S63: YES), the CPU 111 permits participation in the Web conference (S65). On the other hand, when the actual total number of participants is not smaller than the number of licenses (S63: NO), the CPU 111 prohibits participation in the Web conference (S71). For example, the CPU 111 causes the terminal apparatus 12 having transmitted the sixth command to display a disapprove screen indicating that participation in the Web conference is not permitted. For example, the CPU 111 may transmit display data of the disapprove display, or may transmit a command for controlling the CPU 121 of the terminal apparatus 12 having transmitted the sixth command to display the disapprove screen.

In a case where the actual total number of participants is smaller than the number of licenses, the actual total number of participants does not become larger than the number of licenses even if participation in the Web conference is permitted in response to a request. Hence, the CPU 111 permits participation in a Web conference in response to a request, thereby permitting participation in the Web conference within an acceptable range of the number of licenses. On the other hand, when the actual total number of participants is not smaller than the number of licenses, the CPU 111 can suppress the actual total number of participants from becoming larger than the number of licenses by prohibiting the request for participating in the Web conference.

### First Modification

A first modification will be described. A first main process (FIGS. 4 and 5) and a second main process (FIG. 11) excluding a determining process shown in FIG. 12 are executed in the first modification. The first main process and the second main process (excluding the determining process) are the same as the above-described embodiment, and hence the descriptions will be omitted. In the first modification, when it is determined that the actual total number of participants is not smaller than the number of licenses (S63: NO), the CPU 111 executes a determining process shown in FIG. 13 instead of the determining process shown in FIG. 12.

The determining process in the first modification will be described while referring to FIG. 13. The CPU 111 identifies, in the second table 114B shown in FIG. 2, identical group user IDs including the user ID acquired in S61 shown in FIG. 11, based on the “group ID” corresponding to the user ID acquired in S61 shown in FIG. 11. The CPU 111 extracts records including the same “user ID” as the identified identical group user ID out of the first table 114A shown in FIG. 2 (S81).

The CPU 111 identifies the latest “reservation date and time” in “reservation date and time” included in the extracted records, and further identifies “conference ID” corresponding to the identified “reservation date and time” (S83). The CPU 111 determines whether the identified conference ID is identical to the conference ID acquired in S61 shown in FIG. 11 (S85). When it is determined that these conference IDs are identical (S85: YES), the CPU 111 prohibits participation in the Web conference identified by the conference ID acquired in S61 shown in FIG. 11 (S87). The CPU 111 returns the process to the second main process shown in FIG. 11.

When it is determined that the identified conference ID is not identical to the conference ID acquired in S61 shown in FIG. 11 (S85: NO), the CPU 111 terminates the Web conference identified by the identified conference ID (S89). Specifically, the CPU 111 extracts a record including the same “conference ID” as the “conference ID” corresponding to the latest “reservation date and time” out of the seventh table 113C shown in FIG. 3. The CPU 111 identifies “address information” included in the extracted record. The CPU 111 ends the session of the Web conference with the terminal apparatus 12 corresponding to the identified “address information”. The CPU 111 deletes a record including the same “conference ID” as the conference ID identifying the terminated Web conference in the seventh table 113C shown in FIG. 3.

The CPU 111 permits participation in the Web conference identified by the conference ID acquired in S61 shown in FIG. 11 (S91). The CPU 111 stores the conference ID and the user ID acquired in S61 shown in FIG. 11 in the seventh table 113C shown in FIG. 3. The CPU 111 further stores “address information” of the terminal apparatus 12 having transmitted the sixth command in the seventh table 113C, in association with the stored “user ID”. The CPU 111 calculates the total number of the “user ID” corresponding to the added “conference ID” in the seventh table 113C, and stores the total number in the seventh table 113C as the “number of participants”. The CPU 111 ends the second main process.

### Main Effects of First Modification

As described above, in the first modification, when the reservation date and time of the Web conference for which participation has been requested is the latest “reservation date and time” in the first table 114A shown in FIG. 2 (S85: YES), the CPU 111 of the management apparatus 11 prohibits participation in the Web conference (S87). For example, the CPU 111 causes the terminal apparatus 12 having transmitted the sixth command to display a disapprove screen indicating that participation in the Web conference is not permitted. For example, the CPU 111 may transmit display data of the disapprove screen, or may transmit a command for controlling the CPU 121 of the terminal apparatus 12 having transmitted the sixth command to display the disapprove screen. On the other hand, when the reservation date and time of the Web conference for which participation has been requested is not the latest “reservation date and time” in the first table 114A shown in FIG. 2 (S85: NO), the CPU 111 terminates the Web conference identified by the “conference ID” corresponding to the latest “reservation date and time” (S89). With this process, a Web conference having an earlier reservation date and time can be executed preferentially while suppressing the actual total number of participants from becoming larger than the number of licenses.

For example, the following case will be described. That is, when reservation of a Web conference is performed through the reservation screen 2 shown in FIG. 6 and displayed on the display 126 of the terminal apparatus 12, the screen is switched to the reservation screen 2A to which highlighting is added as shown in FIG. 7. This indicates that the number of all the participants who plan to participate in Web conferences scheduled to be conducted in the same time slot exceeds the number of licenses. Hence, when Web conferences are actually conducted in this time slot, there is a case that one of the Web conferences is terminated by the determining process in the above-described first modification. Accordingly, attention information may be displayed, for example, by a popup window indicating that there is a possibility that the Web conference cannot be executed in a case where the Web conference is actually conducted in this time slot.

### Second Modification

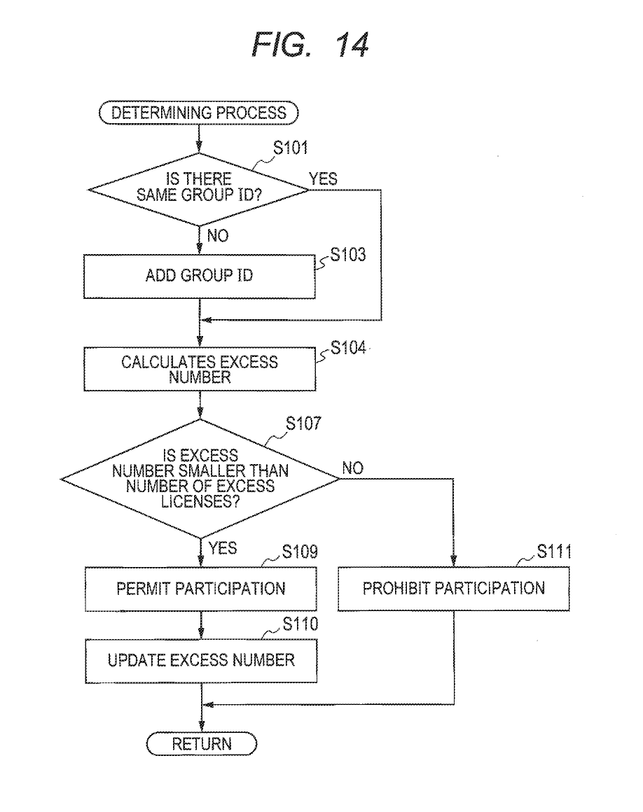

A second modification will be described. The first main process (FIGS. 4 and 5) and the second main process (FIG. 11) excluding a determining process shown in FIG. 12 are executed in the second modification. The first main process and the second main process (excluding the determining process) are the same as the above-described embodiment, and hence the descriptions will be omitted. In the second modification, when it is determined that the actual total number of participants is not smaller than the number of licenses (S63: NO), the CPU 111 executes a determining process shown in FIG. 14 instead of the determining process shown in FIG. 12.

The determining process will be described while referring to FIG. 14. The CPU 111 identifies “group ID” corresponding to the user ID acquired in S61 shown in FIG. 11 in the second table 114B shown in FIG. 2. The CPU 111 determines whether the fourth table 114D shown in FIG. 2 stores the same “group ID” as the identified group ID (S101). When it is determined that the fourth table 114D stores the same “group ID” as the identified group ID (S101: YES), the CPU 111 advances the process to S104. When it is determined that the fourth table 114D does not store the same “group ID” as the identified group ID (S101: NO), the CPU 111 adds and stores the identified group ID in the fourth table 114D (S103). The CPU 111 advances the process to S104.

The CPU 111 identifies the “number of licenses” and the “number of excess licenses” corresponding to the identified group ID in the third table 114C shown in FIG. 2. The CPU 111 calculates the excess number by subtracting the identified number of licenses from the actual total number of participants calculated in S62 shown in FIG. 11 (S104).

The CPU 111 determines whether the excess number calculated in S104 is smaller than the identified number of excess licenses (S107). When it is determined that the excess number is smaller than the number of excess licenses (S107: YES), the CPU 111 permits participation in the Web conference identified by the conference ID acquired in S61 shown in FIG. 11 (S109). The CPU 111 stores the conference ID and the user ID acquired in S61 shown in FIG. 11 in the seventh table 113C shown in FIG. 3. The CPU 111 further stores the “address information” of the terminal apparatus 12 having transmitted the sixth command in the seventh table 113C, in association with the stored “user ID”. The CPU 111 calculates the total number of the stored “user ID” in the seventh table 113C, and stores the total number in the seventh table 113C as the “number of participants”.

The CPU 111 identifies, in the first table 114A shown in FIG. 2, “user ID” corresponding to the conference ID acquired in S61 shown in FIG. 11. The CPU 111 identifies, in the second table 114B shown in FIG. 2, the identical group user ID including the identified user ID, based on the “group ID” corresponding to the identified user ID. The CPU 111 extracts records including the same “user ID” as the identified identical group user ID out of the first table 114A shown in FIG. 2. The CPU 111 identifies “conference ID” included in the extracted record. The CPU 111 extracts a record including the identified “conference ID” out of the seventh table 113C shown in FIG. 3. The CPU 111 counts the number of “participants” included in the extracted record, and calculates the number as the actual total number of participants. The CPU 111 calculates the excess number by subtracting the number of licenses from the actual number of participants. The CPU 111 changes the “excess number” of the fourth table 114D shown in FIG. 2 to the calculated excess number, and updates the “excess number” (S110). The CPU 111 acquires the current date and time from the OS, and stores the acquired current date and time in the fourth table 114D as the “excess date and time”. The CPU 111 ends the determining process, and returns the process to the second main process shown in FIG. 11.

On the other hand, when it is determined that the excess number is not smaller than the number of excess licenses (S107: NO), the CPU 111 prohibits participation in the Web conference identified by the conference ID acquired in S61 shown in FIG. 11 (S111). For example, the CPU 111 causes the terminal apparatus 12 having transmitted the sixth command to display a disapprove screen indicating that participation in the Web conference is not permitted. For example, the CPU 111 may transmit display data of the disapprove screen, or may transmit a command for controlling the CPU 121 of the terminal apparatus 12 having transmitted the sixth command to display the disapprove screen. The CPU 111 ends the determining process, and returns the process to the second main process shown in FIG. 11.

### Main Effects of Second Modification

As described above, in the second modification, when the excess number is smaller than the number of excess licenses (S107: YES), the CPU 111 of the management apparatus 11 permits participation in a Web conference in response to a request (S109). With this process, the CPU 111 permits participation in a Web conference within the acceptable range of the number of excess licenses. On the other hand, when the excess number is not smaller than the number of excess licenses (S107: NO), the CPU 111 prohibits participation in the Web conference (S111). With this process, the CPU 111 suppresses the excess number from becoming larger than the number of excess licenses.

### Third Modification

A part of processes corresponding to the first main process shown in FIGS. 4 and 5 may be executed by the CPU 121 of the terminal apparatus 12. Hereinafter, a third modification will be described in detail while referring to FIGS. 4 and 5. In the flowchart of FIG. 4, “Transmit login screen” in S11 is changed to “Display login screen”. “Acquire user ID and password” in S13 is changed to “Transmit user ID and password”. “Transmit first selection screen” in S15 is changed to “Display first selection screen”. “Transmit second selection screen” in S19 is changed to “Display second selection screen”. “Transmit reservation screen” in S25 is changed to “Display reservation screen”. “Acquire scheduled date and time and the number of participants” in S27 is changed to “Transmit scheduled date and time and the number of participants”. “Transmit highlighted reservation screen” in S35 is changed to “Display highlighted reservation screen”. In the flowchart of FIG. 5, “Transmit calendar” in S55 is changed to “Display calendar”. The process of S37 in FIG. 4 is not executed. The tables 113A, 113B shown in FIG. 3 are stored in the RAM 123 of the terminal apparatus 12.

The first main process executed by the CPU 121 of the terminal apparatus 12 will be described in detail while referring to the flowchart of FIG. 4. In response to detecting that an input operation for displaying a login URL on the display 126 has been performed through the input device 128, the CPU 121 starts the first main process after transmitting the first command to the management apparatus 11.

After transmitting the first command, the CPU 121 receives data of a login screen (not shown) from the management apparatus 11 through the communication I/F 127. The CPU 121 displays the login screen on the display 126 based on the received data (S11). In response to detecting, through the input device 128, an operation of inputting a user ID and a password through the displayed login screen, the CPU 121 identifies the inputted user ID and password. The CPU 121 transmits the second command including the identified user ID and password to the management apparatus 11 through the communication I/F 127 (S13).

In response to receiving the second command from the terminal apparatus 12 through the communication I/F 115, the CPU 111 of the management apparatus 11 authenticates the terminal apparatus 12 based on the user ID and the password included in the received second command and on the second table 114B shown in FIG. 2. When the authentication succeeds, the CPU 111 transmits data of the first selection screen (not shown) to the terminal apparatus 12 through the communication I/F 115.

The CPU 121 of the terminal apparatus 12 receives data of the first selection screen from the management apparatus 11 through the communication I/F 127. The CPU 121 displays the first selection screen on the display 126, based on the received data (S15). In response to detecting that an input operation of selecting one of “reserve” or “view” in the displayed first selection screen has been performed through the input device 128, the CPU 121 transmits the third command including information indicative of the selected “reserve” or “view” to the management apparatus 11 through the communication I/F 127.

The CPU 111 of the management apparatus 11 receives the third command from the terminal apparatus 12 through the communication I/F 115. The CPU 111 determines whether “reserve” is selected, based on the received third command. When it is determined that “reserve” is selected, the CPU 111 transmits data of the reservation screen 2 shown in FIG. 6 to the terminal apparatus 12 having transmitted the third command through the communication I/F 115.

In response to receiving data of the reservation screen 2 shown in FIG. 6 from the management apparatus 11 through the communication I/F 127 (S17: YES), the CPU 121 of the terminal apparatus 12 displays the reservation screen 2 on the display 126 based on the received data (S25). In response to detecting that an input operation of selecting the reservation instructing section 26 in the reservation screen 2 shown in FIG. 6 has been performed through the input device 128, the CPU 121 calculates, as the end time, the time at which the duration inputted to the duration input section 24, 25 elapses from the start time inputted to the start-time input section 22. The CPU 121 transmits, to the management apparatus 11 through the communication I/F 127, the fourth command including the scheduled date inputted to the scheduled-date input section 21, the start time inputted to the start-time input section 22, the calculated end time, and the number of participants inputted to the number-of-participant input section 23 (S27).

The CPU 111 of the management apparatus 11 receives the fourth command from the terminal apparatus 12 through the communication I/F 115, and acquires the scheduled date and time and the number of participants. The CPU 111 identifies “group ID” corresponding to the user ID included in the received second command in the second table 114B shown in FIG. 2, and further identifies, as “identical group user ID”, the “user ID” associated with the same “group ID” as the identified group ID. The CPU 111 extracts records including the same “user ID” as the identified identical group user ID out of the first table 114A shown in FIG. 2. The CPU 111 transmits the extracted records to the terminal apparatus 12 through the communication I/F 115.

The CPU 121 of the terminal apparatus 12 receives the record transmitted from the management apparatus 11 through the communication I/F 127. The CPU 121 executes the processes of S28 to S31 based on the received record, the tables 114B and 114C stored in the storage 114 of the management apparatus 11, and the tables 113A and 113B shown in FIG. 3. Note that the CPU 121 acquires the tables 114B and 114C from the management apparatus 11 as necessary, and executes processes. The processes of S28 to S31 are identical to the case where the CPU 111 of the management apparatus 11 executes the first main process, and thus descriptions will be omitted.

The CPU 121 determines whether the addition value calculated in S31 is larger than the number of licenses (S33). When it is determined that the addition value is larger than the number of licenses (S33: YES), the CPU 121 displays the reservation screen 2A in which highlighting is added and shown in FIG. 7, instead of the reservation screen 2 that is displayed on the display 126 as shown in FIG. 6 (S35). In response to detecting that an input operation of selecting the reservation instructing section 26 in the reservation screen 2A has been performed through the input device 128, the CPU 121 transmits, to the management apparatus 11 through the communication I/F 127, a command indicating that the reservation instructing section 26 is selected.

In response to receiving, from the terminal apparatus 12 through the communication I/F 115, the command indicating that the reservation instructing section 26 is selected, the CPU 111 of the management apparatus 11 identifies the start date and time and the end date and time, based on the scheduled date and time acquired from the fourth command. The CPU 111 stores, in the first table 114A, a value obtained by adding “1” to the largest “conference ID” in the “conference ID”s already stored in the first table 114A shown in FIG. 2, as the “conference ID”. The CPU 111 stores “conference ID” in the first table 114A in association with the identified “start date and time” and “end date and time”. The CPU 111 further stores the “user ID” acquired from the second command and the “number of participants” acquired from the fourth command in the first table 114A in association with the “conference ID”. The CPU 111 acquires the current date and time from the OS. The CPU 111 further stores the acquired current date and time as “reservation date and time” in the first table 114A, in association with the “conference ID”.

On the other hand, when data of the reservation screen 2 shown in FIG. 6 is not received from the management apparatus 11 (S17: NO), the CPU 121 receives data of the second selection screen from the management apparatus 11. The CPU 121 displays the second selection screen on the display 126, based on the received data (S19). The CPU 121 selects one of the “daily calendar”, “weekly calendar”, and “monthly calendar”, and detects that an input operation specifying “date” has been performed in the displayed second selection screen through the input device 128. The CPU 121 transmits the fifth command including the “date”.

The CPU 111 of the management apparatus 11 receives the fifth command from the terminal apparatus 12. The CPU 111 identifies date included in the fifth command. The CPU 111 identifies, in the second table 114B shown in FIG. 2, the identical group user ID including the user ID based on the group ID corresponding to the user ID included in the received second command. The CPU 111 extracts a record including the same “user ID” as the identified identical group user ID out of the first table 114A shown in FIG. 2. The CPU 111 transmits the extracted record to the terminal apparatus 12 through the communication I/F 115.

The CPU 121 of the terminal apparatus 12 receives the record transmitted from the management apparatus 11 through the communication I/F 127. When it is determined that “daily calendar” is selected (S21: YES), the CPU 121 generates the daily calendar screen 3 shown in FIG. 8 by executing the processes of S41 to S51 in FIG. 5 based on the received record, the tables 114B and 114C stored in the storage 114 of the management apparatus 11, and the tables 113A and 113B shown in FIG. 3. When it is determined that “weekly calendar” is selected (S21: NO, S23: YES), the CPU 121 generates the weekly calendar screen 4 shown in FIG. 9 by executing the processes of S41 to S51 in FIG. 5. When it is determined that “monthly calendar” is selected (S23: NO), the CPU 121 generates the monthly calendar screen 5 shown in FIG. 10 by executing the processes of S41 to S51 in FIG. 5. Note that the processes of S41 to S51 are identical to the case where the CPU 111 of the management apparatus 11 executes the first main process, and thus descriptions will be omitted. The CPU 121 displays the generated screen on the display 126 (S55).

### Main Effects of Third Modification

As described above, the CPU 121 of the terminal apparatus 12 generates one of the “daily calendar screen 3”, the “weekly calendar screen 4”, and the “monthly calendar screen 5” based on information stored in the first table 114A transmitted from the management apparatus 11, and displays the generated screen on the display 126. In this case, the CPU 111 of the management apparatus 11 does not need to generate a screen. Accordingly, the processing burden on the CPU 111 can be reduced. Further, the size of transmission data is reduced, compared with a case where screen data is transmitted from the management apparatus 11 to the terminal apparatus 12. Accordingly, the CPU 121 reduces the burden of communication of the Internet 14.

Note that, in the above-described third modification, the CPU 111 of the management apparatus 11 may transmit the entire first table 114A to the terminal apparatus 12. The CPU 121 of the terminal apparatus 12 may extract a record including the same “user ID” as the identical group ID in the first table 114A received from the management apparatus 11, and may execute the above-described process based on the extracted record.

### Other Modifications

While the disclosure has been described in detail with reference to the above aspects thereof, it would be apparent to those skilled in the art that various changes and modifications may be made therein without departing from the scope of the claims.

In the above-described embodiment, the CPU 111 generates each of the daily calendar screen 3, the weekly calendar screen 4, and the monthly calendar screen 5 (S49, S51). The CPU 111 transmits data indicative of the generated screen to the terminal apparatus 12 having transmitted the fifth command (S55). However, the CPU 111 may generate calendar generating command information for generating each of the daily calendar screen 3, the weekly calendar screen 4, and the monthly calendar screen 5 by the processes of S49 and SM. The CPU 111 may transmit the generated calendar generating command information to the terminal apparatus 12 having transmitted the fifth command through the communication I/F 115 (S55). In response to receiving the calendar generating command information, the CPU 121 of the terminal apparatus 12 may generate the calendar screen 4, 5, 6 based on the received calendar generating command information, and may display the generated screen on the display 126.

As the calendar generating command information, information indicative of whether the total number of participants is larger than the number of licenses may be generated by the unit of one hour by each date. As the calendar generating command information, the total number of participants and the number of licenses may be generated by the unit of one hour by each date. In this case, the CPU 121 of the terminal apparatus 12 may identify the relationship between the total number of participants and the number of licenses, by each date and by the unit of one hour. In the case of generating each of the daily calendar screen 3, the weekly calendar screen 4, and the monthly calendar screen 5, when the total number of participants is larger than the number of licenses, the CPU 121 may add highlighting to each screen.

In this modification, the CPU 111 causes the terminal apparatus 12 to generate each of the daily calendar screen 3, the weekly calendar screen 4, and the monthly calendar screen 5. Hence, because the process of generating each of the daily calendar screen 3, the weekly calendar screen 4, and the monthly calendar screen 5 is not needed, the CPU 111 can reduce the processing burden.

In the above-described embodiment, when the total number of participants is larger than the number of licenses (S33: YES), the CPU 111 transmits screen data including the highlighting 231 (S35). When the total number of participants is larger than the number of licenses (S47: YES), the CPU 111 transmits screen data including highlighting (the number-of-participant display section 321, the schedule display section 411, 511) (S55). However, the CPU 111 may change a mode of highlighting, based on the total number of participants relative to a particular threshold value depending on the number of licenses. For example, the CPU 111 may transmit screen data including highlighting through the communication I/F 115 when the total number of participants becomes large relative to a threshold value that is calculated by multiplying/adding/subtracting a predetermined value by/to/from the number of licenses. Alternatively, the CPU 111 may change the mode of highlighting, depending on the ratio of the total number of participants to the number of licenses. This ratio may be 0.5 to 1.0, for example. In this case, for example, the CPU 111 may set density of color applied to each of the number-of-participant display section 321, the schedule display sections 411, 511 such that the color becomes darker as the ratio of the total number of participants to the number of licenses increases.

When it is determined that the addition value is larger than the number of licenses (S33: YES), the CPU 111 transmits data of the reservation screen 2A including the highlighting 231 shown in FIG. 7 (S35). However, the CPU 111 may change the mode of the highlighting 231 as described above, based on the relationship between a particular threshold value depending on the number of licenses and the addition value.

In the above-described embodiment, the upper limit of the total number of participants is set as the number of licenses. However, for example, the upper limit of the total number of conferences that are concurrently conducted may be set as the number of licenses, instead of the total number of participants. In this case, the CPU 111 may generate one of the daily calendar screen 3, the weekly calendar screen 4, and the monthly calendar screen 5 based on the relationship between the number of licenses and the total number of Web conferences that are concurrently conducted, and may transmit data to the terminal apparatus 12. Alternatively, both of the upper limit of the total number of participants and the upper limit of the total number of conferences may be set as the number of licenses.

In the above-described embodiment, the fourth command transmitted from the terminal apparatus 12 that makes reservation of a Web conference includes the “scheduled date and time” and the “number of participants”. Here, in a case where the total number of Web conferences is set as the number of licenses as described above, the fourth command need not include the “number of Web conference”. This is because a Web conference is reserved one by one, and the “number of Web conference” inevitably becomes “1”. Similarly, in the case where the total number of Web conferences is set as the number of licenses, the first table 114A need not include the “number of Web conference”. The CPU 111 may identify the number of records stored in the first table 114A as the “total number of Web conferences”.

In the above-described embodiment, the fourth command transmitted from the terminal apparatus 12 that makes reservation of a Web conference may include information for calculating the “number of participants”, instead of the “number of participants”. For example, the fourth command may include ID, Email address, name, and so on, of each participant. In response to receiving the fourth command, the CPU 111 may identify the “number of participants” by counting the number of the IDs, the Email addresses, and the names.

In the above-described embodiment, the CPU 111 identifies the time scheduled to conduct a Web conference as the unit scheduled time by the unit of one hour (S28, S30). The CPU 111 may identify the unit scheduled time, not by the unit of one hour. For example, the CPU 111 may identify the unit scheduled time by the unit of one minute, by the unit of 30 minutes, by the unit of two hours, by the unit of twelve hours, by the unit of one day, or the like.

In the above-described embodiment, the CPU 111 identifies the total number of participants for each group. Note that, in the above-described embodiment, the group is a department to which users belong. However, the group may be another organization. For example, the group may be a company, attributes of users (president, senior managing director, director, manager, supervisor, and so on), or types of work (development, design, sales, accounting, and so on). Alternatively, the group may be user himself/herself. That is, a license of Web conference may be given to each user.

In each of the daily calendar screen 3, the weekly calendar screen 4, and the monthly calendar screen 5, it is possible to change the display mode in the case where the total number of participants is larger than the number of licenses. For example, in each of the daily calendar screen 3, the weekly calendar screen 4, and the monthly calendar screen 5, when the total number of participants is larger than the number of licenses, a popup window for notifying attention may be displayed in an overlapping manner with the screen.

In the above-described embodiment, regardless of the relationship between the addition value and the number of licenses (S33: YES or NO), the CPU 111 stores, in the first table 114A, the scheduled date and time and the number of participants included in the fourth command (S37). However, when the addition value is larger than the number of licenses (S33: YES), the CPU 111 need not store, in the first table 114A, the scheduled date and time and the number of participants included in the fourth command.

In the above-described first modification, the CPU 111 terminates the Web conference having the latest reservation date and time (S89). However, the CPU 111 may cancel participation of at least one participant who participates in the Web conference having the latest reservation date and time.

In the above-described embodiment, the number of licenses and the number of excess licenses are set for each group. The number of excess licenses is the upper limit of the excess number that is calculated by subtracting the number of licenses from the total number of participants. However, the number of excess licenses may be the upper limit of the number of participants and may be a value larger than the number of licenses. When it is determined that the actual total number of participants is larger than or equal to the number of licenses (S63: NO), the CPU 111 may determine whether to permit participation in the Web conference by comparing the actual total number of participants with the number of excess licenses (S107).

At least part of the processes included in the above-described first main process shown in FIGS. 4 and 5 may be executed by the CPU 121 of the terminal apparatus 12. That is, each CPU of the plurality of apparatuses included in the communication system 1 may execute a part of the first main process.

In the above-described embodiment, the CPU 111 of the management apparatus 11 transmits each data of the reservation screen 2 shown in FIG. 6, the reservation screen 2A shown in FIG. 7, and the calendar screens 4, 5, 6 shown in FIGS. 8 to 10, to the logged-in terminal apparatus 12, more specifically, the terminal apparatus 12 used by the user who is authenticated based on the password acquired in S13. However, the CPU 111 may transmit each data of the above-described screens to the terminal apparatus 12 other than the logged-in terminal apparatus 12.

What is claimed is:

1. A method performed in a communication system configured to conduct a Web conference among a plurality of terminal apparatuses, the method comprising:
receiving, through a communication interface, scheduled date and time and reservation conference information, the scheduled date and time being date and time on which a Web conference is scheduled to be conducted, and the reservation conference information including a number of license targets;
storing, in a storage, conference identification information identifying the Web conference, the scheduled date and time, and the number of license targets in association with one another;
counting a total number of the number of license targets of associated Web conferences conducted on the scheduled date and time in a particular period based on the scheduled date and time and the number of license targets stored in the storage, the associated Web conferences being Web conferences associated with a requesting user who requests a reservation status of the Web conferences;
generating reservation status information indicative of a reservation status of the associated Web conferences, based on a number of licenses associated with the requesting user and on the total number of the number of license targets in the particular period counted by the counting, the number of licenses defining an upper limit of the number of license targets; and
controlling to display the reservation status information on a display of one of the plurality of terminal apparatuses corresponding to the requesting user.

2. A non-transitory computer-readable storage medium storing a program executable on a computer of a management apparatus configured to manage reservation of Web conferences conducted by a plurality of terminal apparatuses, the program causing, when executed, the management apparatus to perform operations comprising:
a reservation receiving operation of receiving, through a communication interface of the management apparatus, scheduled date and time and reservation conference information, the scheduled date and time being date and time on which a Web conference is scheduled to be conducted, and the reservation conference information including a number of license targets;
a storing controlling operation of storing, in a storage, conference identification information identifying the Web conference, the scheduled date and time, and the number of license targets in association with one another;
a first counting operation of counting a total number of the number of license targets of associated Web conferences conducted on the scheduled date and time in a particular period based on the scheduled date and time and the number of license targets stored in the storage, the associated Web conferences being Web conferences associated with a requesting user who requests a reservation status of the Web conferences;
a generating operation of generating reservation status information indicative of a reservation status of the associated Web conferences, based on a number of licenses associated with the requesting user and on the total number of the number of license targets in the particular period counted by the first counting operation, the number of licenses defining an upper limit of the number of license targets; and
a first transmitting operation of transmitting, through the communication interface, the reservation status information generated by the generating operation to at least one of the plurality of terminal apparatuses.

3. The storage medium according to claim 2, wherein the generating operation comprises generating, as the reservation status information, calendar information indicative of a calendar including highlighting in a case where the total number of the number of license targets satisfies a particular relationship relative to the number of licenses.

4. The storage medium according to claim 3, wherein the generating operation comprises generating, as the reservation status information, the calendar information indicative of a calendar including highlighting on the scheduled date and time corresponding to the total number of the number of license targets satisfying the particular relationship.

5. The storage medium according to claim 3, wherein the number of license targets is a number of participants who participate in the Web conference; and
wherein the generating operation comprises generating, as the reservation status information, the calendar information that shows a total number of participants for each of the scheduled date and time, the total number of participants being a total number of the number of the participants counted by the first counting operation.

6. The storage medium according to claim 2, wherein the generating operation comprises, when the total number of the number of license targets satisfies a particular relationship relative to the number of licenses, generating, as the reservation status information, calendar generating command information for commanding a terminal apparatus having transmitted the reservation conference information to generate a calendar including highlighting, the terminal apparatus being one of the plurality of terminal apparatuses.

7. The storage medium according to claim 2, wherein the associated Web conferences are Web conferences that are reserved by users associated with attribute information that is set to the requesting user.

8. The storage medium according to claim 2, wherein the program further causes, when executed, the management apparatus to perform operations comprising a first determining operation of, after receiving the scheduled date and time and the number of license targets by the reservation receiving operation, determining whether a value based on the total number of the number of license targets of associated Web conferences to be conducted on the scheduled date and time in the particular period is larger than the number of licenses.

9. The storage medium according to claim 8, wherein the storing controlling operation comprises:
in response to determining in the first determining operation that the value based on the total number of the number of license targets is larger than the number of licenses, storing the scheduled date and time and the number of license targets in the storage; and
in response to determining in the first determining operation that the value based on the total number of the number of license targets is less than or equal to the number of licenses, storing the scheduled date and time and the number of license targets in the storage.

10. The storage medium according to claim 8, wherein the storing controlling operation comprises storing the scheduled date and time and the number of license targets in the storage, regardless of whether the value based on the total number of the number of license targets is larger than the number of licenses.

11. The storage medium according to claim 2, wherein the program further comprises:
a second determining operation of, in response to receiving the scheduled date and time and the number of license targets by the reservation receiving operation, determining whether a value based on the total number of the number of license targets of associated Web conference to be conducted on the scheduled date and time in the particular period satisfies a particular relationship relative to the number of licenses; and
a second transmitting operation of, in response to determining by the second determining operation that the particular relationship is satisfied, transmitting, through the communication interface, display information indicating that the particular relationship is satisfied.

12. The storage medium according to claim 11, wherein the second determining operation comprises determining whether the value is larger than the number of licenses, and
wherein the second transmitting operation comprises, in response to determining by the second determining operation that the value is larger than the number of licenses, transmitting display information indicating that there is a possibility that the Web conference is not conducted.

13. The storage medium according to claim 2, wherein the program further causes, when executed, the management apparatus to perform operations comprising:
a participation receiving operation of receiving, from a terminal apparatus through the communication interface, a request to participate in a Web conference identified by the conference identification information stored in the storage; and
a first permitting operation of permitting the terminal apparatus from which the request is received to participate in the Web conference, when a total number of an actual number of license targets is less than the number of licenses, the actual number of license targets being the number of license targets in each of the associated Web conferences in a same time slot as the Web conference for which the request is received by the participation receiving operation.

14. The storage medium according to claim 13, wherein the program further causes, when executed, the management apparatus to perform operations comprising:
a first prohibiting operation of, when the total number of the actual number of license targets is larger than or equal to the number of licenses, prohibiting participation in the Web conference by the terminal apparatus from which the request is received by the participation receiving operation.

15. The storage medium according to claim 14, wherein the first prohibiting operation comprises causing the terminal apparatus from which the request is received to display the disapprove screen, the disapprove screen indicating that the terminal apparatus is not permitted to participate in the Web conference.

16. The storage medium according to claim 13, wherein the storing controlling operation further comprises storing reservation date and time in association with the conference identification information, the reservation date and time being date and time on which the scheduled date and time and the number of license targets are received by the reservation receiving operation; and
wherein the program further causes, when executed, the management apparatus to perform operations comprising a second permitting operation of, when the total number of the actual number of license targets is larger than or equal to the number of licenses, reducing the actual number of license targets in a Web conference having the conference identification information corresponding to a latest reservation date and time out of the associated Web conferences, and permitting the terminal apparatus from which the request is received to participate in the Web conference.

17. The storage medium according to claim 13, wherein the program further comprises:
an excess determining operation of, when the total number of the actual number of license targets is larger than or equal to the number of licenses, determining whether an excess number is larger than a particular number of excess licenses, the excess number being obtained by subtracting the number of licenses from the total number of the actual number of license targets; and
a third permitting operation of, in response to determining by the excess determining operation that the excess number is less than or equal to the particular number of excess licenses, permitting the terminal apparatus from which the request is received to participate in the Web conference, without executing the third permitting operation in response to determining that the excess number is larger than the particular number of excess licenses.

18. The storage medium according to claim 8, wherein the program further causes, when executed, the management apparatus to perform operations comprising a second counting operation of counting an addition value that is obtained by adding the total number of the number of license targets to the number of license targets received by the reservation receiving operation, as the value based on the total number of the number of license targets.

19. A non-transitory computer-readable storage medium storing a program executable on a computer of a terminal apparatus configured to make a reservation of a Web conference managed by a management apparatus, the program causing, when executed, the terminal apparatus to perform operations comprising:
a first transmitting operation of transmitting, to the management apparatus through a communication interface of the terminal apparatus, user identification information identifying a user, scheduled date and time that is date and time on which a Web conference is scheduled to be conducted, and reservation conference information including a number of license targets;
a first counting operation of counting a total number of the number of license targets of associated Web conferences to be conducted on the scheduled date and time in a particular period, the associated Web conferences being associated with the user identification information transmitted by the first transmitting operation;
a generating operation of generating reservation status information indicative of a reservation status of the associated Web conferences, based on a number of licenses associated with the user identification information transmitted by the first transmitting operation and on the total number of the number of license targets in the particular period counted by the first counting operation, the number of licenses defining an upper limit of the number of license targets; and
a displaying operation of displaying, on a display of the terminal apparatus, the reservation status information generated by the generating operation.
